(19) United States
(12) Patent Application Publication
(10) Pub. No.: US 2016/0272828 A1
(43) Pub. Date: Sep. 22, 2016

(54) INK, INK CARTRIDGE, INKJET RECORDING METHOD, INKJET RECORDING APPARATUS, AND INK RECORDED MATTER

(71) Applicants: Yukiko TAKAMURA, Wakayama (JP); Tsutomu Maekawa, Kanagawa (JP); Yuuki Yokohama, Kanagawa (JP); Akiko Bannai, Kanagawa (JP); Shosuke Aoai, Shizuoka (JP)

(72) Inventors: Yukiko TAKAMURA, Wakayama (JP); Tsutomu Maekawa, Kanagawa (JP); Yuuki Yokohama, Kanagawa (JP); Akiko Bannai, Kanagawa (JP); Shosuke Aoai, Shizuoka (JP)

(21) Appl. No.: 15/074,480

(22) Filed: Mar. 18, 2016

(30) Foreign Application Priority Data
Mar. 19, 2015 (JP) 2015-056049
Apr. 7, 2015 (JP) 2015-078364

(51) Int. Cl. C09D 11/322; B41J 2/175; C09D 11/102

(52) U.S. Cl. CPC C09D 11/322; C09D 11/102; B41J 2/175

(57) ABSTRACT

An ink including water, a water-soluble organic solvent, a resin-coated pigment coaled with a resin (A), and a resin emulsion including a resin (B) is provided. The resin (B) has the same composition as the resin (A) and a volume average particle diameter of from 8 to 19 nm. The total content rate of the resin (A) and the resin (B) in the ink ranges from 2% to 11% by mass. The content of the resin (B) ranges from 30% to 55% by mass of the total content of the resin (A) and the resin (B).

### CROSS-REFERENCE TO RELATED APPLICATIONS

This patent application is based on and claims priority pursuant to 35 U.S.C. §119(a) to Japanese Patent Application Nos. 2015-056049 and 2015-078364, filed on Mar. 19, 2015 and Apr. 7, 2015, respectively, in the Japan Patent Office, the entire disclosure of each of which is hereby incorporated by reference herein.

### BACKGROUND

1. Technical Field

The present disclosure relates to an ink, an ink cartridge, an inkjet recording method, an inkjet recording apparatus, and ink recorded matter.

2. Description of the Related Art

There are conventional methods in which small droplets of ink are sprayed on a medium to form an image on the surface of the media with the ink or to coat the surface with the ink.

Among such methods, inkjet recording methods, in which small droplets of ink are discharged by means of various mechanisms and allowed to adhere to a recording medium to form dots thereon, are known to be very simple. Inkjet recording apparatuses employing such inkjet recording methods are widely spreading these days thanks to their advantages of compact size, low price, less noise during recording, capability of forming full-color and high-density images, and high printing speed.

Inks used for inkjet recording contain water as a main ingredient, and further contain a colorant and a wetting agent (e.g., glycerin) for suppressing clogging. As the colorant, dyes are mainly used for their excellent color developing ability and stability. However, dye-based inks have a disadvantage that the resulting images are poor at light resistance and water resistance. Although water resistance can be improved to some extent by using a special inkjet recording paper having an ink absorbing layer in combination with a dye-based ink, combined use of a dye-based ink and plain paper never provides excellent water resistance.

In view of this situation, pigment-based inks are used nowadays in place of dye-based inks. Pigment-based inks are greatly improved in light resistance and water resistance, but the resulting images thereof disadvantageously have poor glossiness. This is because light is multiply reflected inside the pigment and light beams having difference wavelengths and phases interfere with each other.

In an image foinied with a pigment-based ink on a recording medium, the pigment is likely to remain near the surface of the recording medium. Thus, unless the pigment is sufficiently fixed on the surface of the recording medium, the pigment comes off when the image is rubbed with a finger or paper sheet (i.e., rub resistance is poor). In particular, when the recording medium is a coated paper sheet that is less ink-absorptive than a plain paper sheet, the pigment is more likely to remain on the surface of the sheet, thereby drastically degrading rub resistance.

### SUMMARY

In accordance with some embodiments of the present invention, an ink is provided. The ink includes water, a water-soluble organic solvent, a resin-coated pigment coated with a resin (A), and a resin emulsion including a resin (B). The resin (B) has the same composition as the resin (A) and a volume average particle diameter of from 8 to 19 nm. The total content rate of the resin (A) and the resin (B) in the ink ranges from 2% to 11% by mass. The content of the resin (B) ranges from 30% to 55% by mass of the total content of the resin (A) and the resin (B).

In accordance with some embodiments of the present invention, an ink cartridge is provided. The ink cartridge includes a container and the above ink contained in the container.

In accordance with some embodiments of the present invention, an inkjet recording method is provided. The inkjet recording method includes the steps of applying a stimulus to the above ink to discharge the ink and recording an image on a recording medium with the ink.

In accordance with some embodiments of the present invention, an inkjet recording apparatus is provided. The inkjet recording apparatus includes an ink discharging device and an image recorder. The ink discharging device applies a stimulus to the above ink to discharge the ink. The image recorder records an image on a recording medium with the ink.

In accordance with some embodiments of the present invention, ink recorded matter is provided. The ink recorded matter includes a recording medium and an image formed on the recording medium with the above ink.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a perspective view of an ink cartridge according to an embodiment of the present invention;

FIG. 2 is a perspective view of an ink supply opening of the ink cartridge before being fitted with a cap;

FIG. 3 is an exploded perspective view of the ink supply opening;

FIGS. 4 and 5 are perspective views of a cap of the ink cartridge, in an initial state and a separated state, respectively;

FIG. 6 is a schematic view of an inkjet recording apparatus according to an embodiment of the present invention;

FIG. 7 is a magnified view of a pretreatment part in the inkjet recording apparatus;

FIG. 8 is a schematic view of a droplet discharge head in the inkjet recording apparatus;

FIG. 9 is amagnified view of the droplet discharge head;

FIG. 10 is a cross-sectional schematic view of the droplet discharge head taken along the longitudinal direction of a liquid chamber in the inkjet recording apparatus; and

FIG. 11 is a cross-sectional schematic view of the droplet discharge head taken along the short direction of the liquid chamber in the inkjet recording apparatus.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

There is a demand for a pigment-based ink which provides high-quality images with rub resistance, glossiness, and image density, and has a good combination of temporal stability, discharge stability, and maintainability.

In accordance with some embodiments of the present invention, a pigment-based ink which provides high-quality images with rub resistance, glossiness, and image density, and has a good combination of temporal stability, discharge stability, and maintainability, is provided.

### Ink

The ink according to an embodiment of the present invention includes water, a water-soluble organic solvent, and a colorant. The ink may optionally include a surfactant, a penetrant, and other components, if needed.

The ink can be used for any purpose, for example, for inkjet recording and spray coating. Preferably, the ink is used for inkjet recording.

The following descriptions are made based on an embodiment in which the ink is used for inkjet recording (hereinafter the ink may be referred to as “inkjet recording ink”).

### Resin

An ink according to an embodiment of the present invention includes water, a water-soluble organic solvent, a resin-coated pigment coated with a resin (A), and a resin emulsion including a resin (B). The resin (B) has the same composition as the resin (A) and a volume average particle diameter of from 8 to 19 nm. The total content rate of the resin (A) and the resin (B) in the ink ranges from 2% to 11% by mass. The content of the resin (B) ranges from 30% to 55% by mass of the total content of the resin (A) and the resin (B).

Here, the resin-coated pigment refers to a pigment coated with a resin, having a core-shell structure in which the pigment serves as the core and the resin serves as the resin. The pigment may be covered with the resin either completely or partially. In the latter case, a part of the pigment (i.e., the core) may be exposed. Another means for dispersing a pigment in ink using a resin (polymer) includes the use of a polymer disperser. However, polymer dispersers have a disadvantage that the resulting dispersion has poor temporal stability since the interaction between a pigment and the polymer disperser is weak. Therefore, the use of the resin-coated pigment, in which a pigment is rigidly coated with a resin, is more preferable.

The ink includes the resin (A) covering the pigment and the resin (B) included in the resin emulsion. The resin (A) and the resin (B) have the same composition. Conventionally, there has been a related-art technology to add such a resin emulsion to an ink composition for improving rub resistance and glossiness of images recorded with the ink. Here, the rub resistance refers to a resistance to rubbing off of pigments in images recorded on a surface of a paper sheet when the images are rubbed with fingers or another paper sheet. However, according to this technology, the interaction between a pigment or the resin covering the pigment and the other resin included in the resin emulsion is so weak that the pigment is rubbed off when the image is rubbed, without being strongly retained on the paper sheet. Namely, images recorded with such an ink are insufficient in terms of rub resistance. Moreover, the images recorded with such an ink are poor in terms of glossiness since the spaces between the pigment particles cannot be filled with the resin in the resin emulsion due to the weak interaction therebetween.

On the other hand, according to an embodiment of the present invention, the resin (A) covering the pigment and the resin (B) included in the resin emulsion have the same composition. This configuration makes the interaction between the resin (A) and the resin

(B) much stronger. The resin (B) goes between the resin-coated pigment particles and strongly bonds them together. Thus, the pigment is never rubbed off even when the image rubbed. In addition, the glossiness of the image is improved since the spaces between the pigment particles are neatly filled with the resin (B).

Here, the resin (A) and the resin (B) having the same composition refers to a state in which the resin (A) and the resin (B) each are polymerized from the same monomers. The type of polymerization (e.g., random, block) and the molecular weight need not be identical. Preferably, the monomer composition for polymerizing the resin (A) has the same compositional ratio as that for polymerizing the resin (B). Determination on whether monomers used for polymerizing the resin (A) are the same as those used for polymerizing the resin (B) is made with respect to monomers which account for 1% by mass or more of the total monomers. Preferably, monomers used for polymerizing the resin (A) and those for polymerizing the resin (B) are completely identical.

The resin (B) is included in the ink in the form of an emulsion. Alternatively, the resin (A) released from the resin-coated pigment and suspended in the ink can function as the resin (B), since the resin (A) and the resin (B) have the same composition. In this case, however, it is relatively difficult to control the release amount or particle diameter of the resin (A). Therefore, adding the resin (B) in the form of an emulsion in the ink is more preferable in terms of operation efficiency.

The total content rate of the resin (A) and the resin (B) in the ink ranges from 2% to 11% by mass, preferably from 6% to 11% by mass. When the total content rate is less than 2% by mass, the adhesive force between the resin-coated pigment particles is lowered and the spaces between the resin-coated pigment particles are not sufficiently filled with the resin. As a result, rub resistance and glossiness of the resulting image deteriorate. Moreover, since the amount of the resin covering the pigment is reduced, dispersion stability of the ink deteriorates. When the total content rate is in excess of 11% by mass, the rate of the pigment to the resin becomes small and the resulting image density is lowered.

The content of the resin (B) ranges from 30% to 55% by mass of the total content of the resin (A) and the resin (B). When the content of the resin (B) is less than 30% by mass, the adhesive force between the resin-coated pigment particles is lowered and the spaces between the resin-coated pigment particles are not sufficiently filled with the resin. As a result, rub resistance and glossiness of the resulting image deteriorate. When the content of the resin (B) is in excess of 55% by mass, the resin (B) adheres and accumulates on the inside of nozzles of an inkjet head, or form its film at the meniscus part of the nozzles upon evaporation of the solvent. As a result, discharge stability and maintainability of the inkjet head at the time of head refreshing deteriorate. Moreover, the resin emulsion in the ink easily aggregates with time, possibly causing a viscosity change.

The content of the resin (B) to the total content of the resin (A) and the resin (B) is calculated in the following manner.

First, the ink is contained in a specific container and subjected to centrifugal separation using a centrifugal separator (himac CS150GX available from Hitachi Koki Co., Ltd.) at 58,000 revolutions per minute (rpm) for 6.5 hours. All of the resulting clear supernatant liquid is collected. The collected supernatant liquid in an amount of 20 mg is weighed as a sample. The sample is subjected to a measurement by a TG-DTA (Thermoplus TG8120 available from Rigaku Corporation) in which the temperature is raised from 25° C. to 500° C. at a rate of 10° C./min under N₂ gas flow at a rate of 500 ml/min and then kept at 500° C. for 30 minutes under the air flow at a rate of 500 ml/min, to obtain a TG curve. The amount (% by mass) of the resin (B) in the supernatant liquid is determined from the obtained TG curve and converted into the amount (% by mass) of the resin (B) in the ink. The value thus obtained is defined as α.

Similarly, the ink without being subjected to centrifugal separation in an amount of 20 mg is subjected to the above measurement to obtain another TG curve. The total amount (% by mass) of the resin (A) and the resin (B) in the ink is calculated from the TG curve. The value thus obtained is defined as β.

The content of the resin (B) to the total content of the resin (A) and the resin (B) is determined by dividing α by β (i.e., α/β).

Examples of the resin (A) and the resin (B) include vinyl polymer, polyester polymer, and polyurethane polymer. Among these polymers, polyurethane polymer is preferable. Polyurethane polymer is capable of improving rub resistance of the resulting image since it has a relatively high hardness and elasticity.

### Vinyl Polymer

Preferred examples of the vinyl polymer include a copolymerization product of a monomer composition including the following monomers (a) to (c): (a) at least one vinyl monomer selected from an acrylic acid ester, a methacrylic acid ester, and a styrene monomer; (b) a polymerizable unsaturated monomer having a salt-forming group; and (c) a compound copolymerizable with the vinyl monomer (a) and the polymerizable unsaturated monomer (b) having a salt-forming group.

Specific examples of the vinyl monomer (a) include, but are not limited to: acrylic acid esters such as methyl acrylate, ethyl acrylate, isopropyl acrylate, n-butyl acrylate, t-butyl acrylate, isobutyl acrylate, n-amyl acrylate, n-hexyl acrylate, n-octyl acrylate, and dodecyl acrylate; methacrylic acid esters such as methyl methacrylate, isopropyl methacrylate, n-butyl methacrylate, t-butyl methacrylate, isobutyl methacrylate, n-amyl methacrylate, 2-ethylhexyl methacrylate, and lauryl methacrylate; and styrene monomers such as styrene, vinyl toluene, and 2-methylstyrene. Each of these monomers can be used alone or in combination with others.

Examples of the polymerizable unsaturated monomer (b) having a salt-forming group include both cationic monomers having a salt-forming group and anionic monomers having a salt-forming group.

Specific examples of the cationic monomers having a salt-forming group include, but are not limited to, tertiary-amine-containing unsaturated monomers and ammonium-salt-containing unsaturated monomers. Specific examples of such cationic monomers include, but are not limited to, N,N-diethylaminoethyl acrylate, N-(N′,N′-dimethylaminoethyl)acrylamide, vinylpyridine, 2-methyl-5-vinylpyridine, dimethylaminoethyl methacrylate, and diethylaminoethyl methacrylate.

Specific examples of the anionic monomers having a salt-forming group include, but are not limited to, unsaturated carboxylic acid monomers, unsaturated sulfonic acid monomers, and unsaturated phosphoric acid monomers. Specific examples of such anionic monomers include, but are not limited to, acrylic acid, methacrylic acid, itaconic acid, maleic acid, and fumaric acid.

Specific examples of the compound (c) copolymerizable with the vinyl monomer (a) and the polymerizable unsaturated monomer (b) having a salt-forming group include, but are not limited to, acrylamide monomers, methacrylamide monomers, hydroxyl-group-containing monomers, and macromers having a polymerizable functional group on one terminal.

Specific examples of the macromers having a polymerizable functional group on one terminal include, but are not limited to, silicone macromers, styrene macromers, polyester macromers, polyurethane macromers, polyalkyl ether macromers, and macromers represented by the following formula: CH₂═C(R⁵)COO(R⁶O)ₚR⁷, wherein R⁵ represents a hydrogen atom or a lower alkyl group, R⁶ represents a divalent hydrocarbon group having 1 to 30 carbon atoms with or without a hetero atom, R⁷ represents a hydrogen atom or a monovalent hydrocarbon group having 1 to 30 carbon atoms with or without a hetero atom, and p represents an integer of from 1 to 60. Each of these macromers can be used alone or in combination with others. Specific examples of the lower alkyl group include, but are not limited to, an alkyl group having 1 to 4 carbon atoms.

Specific preferred examples of the hydroxyl-group-containing monomers include, but are not limited to, 2-hydroxyethyl acrylate and 2-hydroxyethyl methacrylate.

Specific preferred examples of the macromers represented by the formula CH₂═C(R⁵)COO(R⁶O)ₚR⁷ include, but are not limited to, polyethylene glycol (2 to 30) acrylate or methacrylate and methoxypolyethylene glycol (1 to 30)acrylate or methacrylate.

Among these compounds (c), macromers are preferable; and silicone macromers, styrene macromers, and polyalkyl ether macromers are more preferable.

The content rate of the vinyl monomer (a) in the monomer composition is preferably in the range of from 1% to 75% by mass, more preferably from 5% to 60% by mass, and most preferably from 10% to 50% by mass, for improving dispersion stability of the polymer emulsion, but is not limited thereto.

The content rate of the polymerizable unsaturated monomer (b) having a salt-forming group in the monomer composition is preferably in the range of from 2% to 40% by mass, more preferably from 5% to 20% by mass, for improving dispersion stability of the polymer emulsion, but is not limited thereto.

The content rate of the compound (c) copolymerizable with vinyl monomer (a) and the polymerizable unsaturated monomer (b) having a salt-forming group in the monomer composition is preferably in the range of from 5% to 90% by mass, more preferably from 10% to 85% by mass, and most preferably from 20% to 60% by mass, for improving dispersion stability of the polymer emulsion, but is not limited thereto.

### Polyester Polymer

Preferred examples of the polyester polymer include a polycondensation product of alcohol components with carboxylic acid components.

### Alcohol Components

The alcohol components, serving as raw material monomers, preferably include an alkylene oxide adduct of bisphenol A, for improving preserving property of the resulting ink image at high temperatures and fixing strength of the ink image after being dried.

In the present disclosure, the alkylene oxide adduct of bisphenol A refers to 2,2-bis(4-hydroxyphenyl)propane to which at least one oxyalkylene group is adducted.

Specific preferred examples of the alkylene oxide adduct of bisphenol A include a compound represented by the following formula (1).

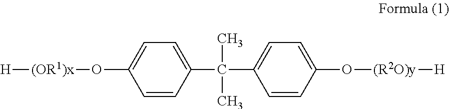

In Formula (1), each of R¹O and R²O independently represents an oxyalkylene group, preferably an oxyalkylene group having 1 to 4 carbon atoms, and more preferably an oxyethylene group or an oxypropylene group, and x and y represent addition molar numbers of respective alkylene oxides.

For improving reactivity with the carboxylic acid components, the average of the sum of x and y is preferably in the range of from 2 to 7, more preferably from 2 to 5, and most preferably from 2 to 3.

(R¹O)x and (R²O)y may have either the same or different configurations. Preferably, (R¹O)x and (R²O)y have the same configurations for improving preserving property of the resulting ink image at high temperatures and fixing strength of the ink image after being dried.

The alkylene oxide adduct of bisphenol A may include either a single compound or a combination of two or more compounds. Preferably, the alkylene oxide adduct of bisphenol A is a propylene oxide adduct of bisphenol A or an ethylene oxide adduct of bisphenol A. More preferably, the alkylene oxide adduct of bisphenol A is a propylene oxide adduct of bisphenol A. Most preferably, the alkylene oxide adduct of bisphenol A is a combination of a propylene oxide adduct of bisphenol A and an ethylene oxide adduct of bisphenol A.

The content rate of the alkylene oxide adduct of bisphenol A in the alcohol components is preferably 50% by mole or more, more preferably 60% by mole or more, and most preferably 70% by mole or more, for improving initial fixing strength of the ink on recording media and preserving property of the resulting ink image at high temperatures. In addition, the content rate of the alkylene oxide adduct of bisphenol A in the alcohol components is preferably 90% by mole or less, more preferably 85% by mole or less, and most preferably 80% by mole or less, for improving initial fixing strength of the ink on recording media and preserving property of the resulting ink image at high temperatures.

The alcohol components may further include the following compounds other than the alkylene oxide adduct of bisphenol A: ethylene glycol, propylene glycol (1,2-propanediol), glycerin, pentaerythritol, trimethylolpropane, hydrogenated bisphenol A, sorbitol, and alkylene (C2-C4) oxide adducts (having an average addition molar number of 1 to 16) thereof.

Each of these alcohol components may be used alone or in combination with the others. Among these alcohol components, 1,2-propanediol, hydrogenated bisphenol A, and a combination thereof are preferable for improving initial fixing strength. For improving ink discharging property, 1,2-propanediol is more preferable. For improving preserving property of the resulting ink image at high temperatures, hydrogenated bisphenol A is more preferable.

In addition, for improving initial fixing strength, a combination of an alkylene oxide adduct of bisphenol A and hydrogenated bisphenol A is preferable, a combination of a propylene oxide adduct of bisphenol A and hydrogenated bisphenol A is more preferable, and a combination of a propylene oxide adduct of bisphenol A, an ethylene oxide adduct of bisphenol A, and hydrogenated bisphenol A is most preferable.

### Carboxylic Acid Components

The carboxylic acid components are also serving as raw material monomers.

Specific examples of the carboxylic acid components include, but are not limited to: aromatic dicarboxylic acids such as phthalic acid, isophthalic acid, and terephthalic acid; aliphatic dicarboxylic acids such as adipic acid, succinic acid, succinic acid having an alkyl group and/or an alkenyl group, and ally alcohol; alicyclic dicarboxylic acids such as cyclohexanedicarboxylic acid and decalin dicarboxylic acid; polycarboxylic acids having 3 or more valences such as trimellitic acid and pyromellitic acid; and anhydrides and alkyl (C1-C3) esters of these acids.

For improving ink discharging property, fixing strength of the ink on recording media, and preserving property of the resulting ink image at high temperatures, aromatic dicarboxylic acids and alicyclic dicarboxylic acids are preferable, and cyclohexanedicarboxylic acid and isophthalic acid are more preferable. For improving preserving property of the resulting ink image at high temperatures and fixing strength of the ink image after being dried, aromatic dicarboxylic acids are preferable, and isophthalic acid is more preferable. Each of these carboxylic acid components may be used alone or in combination with the others.

The carboxylic acid components preferably include a carboxylic acid having a non-aromatic unsaturated carbon-carbon bond, such as an unsaturated aliphatic carboxylic acid and unsaturated alicyclic carboxylic acid.

Specific examples of the carboxylic acid having a non-aromatic unsaturated carbon-carbon bond include, but are not limited to: unsaturated aliphatic carboxylic acids such as fumaric acid, maleic acid, acrylic acid, and methacrylic acid; and unsaturated alicyclic carboxylic acids such as tetrahydrophthalic acid. For improving reactivity, fumaric acid, maleic acid, and tetrahydrophthalic acid are preferable, and fumaric acid is more preferable.

The content rate of the carboxylic acid having a non-aromatic unsaturated carbon-carbon bond in the carboxylic acid components is preferably in the range of from 5% to 30% by mole, more preferably from 7% to 25% by mole, and most preferably from 8% to 20% by mole.

The content rate of the aromatic dicarboxylic acid in the carboxylic acid components is preferably 50% by mole or more, more preferably 70% by mole or more, much more preferably 80% by mole or more, and most preferably 82% by mole or more. In addition, the content rate of the aromatic dicarboxylic acid in the carboxylic acid components is preferably 95% by mole or less, more preferably 92% by mole or less, and most preferably 88% by mole or less.

For properly adjusting the particle diameter of the resin particles and improving fixing strength of the ink on recording media and preserving property of the resulting ink image at high temperatures, the molar ratio (OH/COOH) of the hydroxyl groups in the alcohol components to the carboxyl groups in the carboxylic acid components is preferably in the range of from 100/90 to 100/120, more preferably from 100/95 to 100/110, and most preferably from 100/100 to 100/105.

### Polyurethane Polymer

Preferred examples of the polyurethane polymer include a polyaddition product of diol compounds and diisocyanate compounds. For obtaining proper inkjet properties, monool and/or triol compounds and monoisocyanate and/or triisocyanate compounds can also be used for the polyaddition. For achieving a desired molecular weight, diamine, triamine, and/or tetramine compounds can also be used for the polyaddition.

Specific examples of the diol compounds include, but are not limited to, ethylene glycol, triethylene glycol, tetraethylene glycol, polyethylene glycol, propylene glycol, dipropylene glycol, tripropylene glycol, polypropylene glycol, tetramethylene glycol, polytetramethylene glycol, bisphenol A and alkylene oxide adducts thereof, hydrogenated bisphenol A and alkylene oxide adducts thereof, cyclohexanedimethanol and alkylene oxide adducts thereof, polyester diol, polyurethane diol, bishydroxymethyl propionic acid, and bishydroxymethyl butyric acid. Among these diol compounds, those having 2 to 30 carbon atoms are preferable, and those having 2 to 22 carbon atoms are more preferable.

Specific examples of the diisocyanate compounds include, but are not limited to, hexamethylene diisocyanate, octamethylene diisocyanate, isophorone diisocyanate, tolylene diisocyanate, xylylene diisocyanate, and tetramethylxylylene diisocyanate. Among these diisocyanate compounds, those having 6 to 30 carbon atoms are preferable, and those having 6 to 22 carbon atoms are more preferable.

Each of the diol and diisocyanate compounds may include a functional group such as a hydrocarbon group having 1 to 22 carbon atoms with or without a cyclic structure, carboxyl group, carbonyl group, ester group, and ether group.

The weight average molecular weight of the vinyl polymer, polyester polymer, and polyurethane polymer is preferably in the range of from 5,000 to 500,000, more preferably from 10,000 to 400,000, and most preferably from 10,000 to 300,000, for improving dispersion stability and discharge property, but is not limited thereto.

The weight average molecular weight (Mw) of the resins can be measured by a gel permeation chromatographic (GPC) apparatus (e.g., GPC-8220GPC available from Tosoh Corporation) equipped with three-tandem 15-cm columns TSKgel Super HZM-H (available from Tosoh Corporation). First, the resin to be measured is dissolved in tetrahydrofuran (THF containing a stabilizer, available from Wako Pure Chemical Industries, Ltd.) to prepare a 0.15% by weight solution thereof. The solution is filtered with a 0.2-μm filter. The resulting filtrate is used as a sample solution. Next, 100 μl of the sample solution is injected into the GPC apparatus and subjected to a measurement under a temperature of 40° C. and a flow rate of 0.35 ml/min. The molecular weight of the sample is calculated from the number of counts with reference to logarithmic values on a calibration curve complied with several monodisperse polystyrene standard samples. The polystyrene standard samples include Shodex STANDARD STD. No. S-7300, S-210, S-390, S-875, S-1980, S-10.9, S-629, S-3.0, and S-0.580, available from Showa Denko K.K., and toluene. As a detector, a refractive index (RI) detector is used.

### Preparation of Emulsion of Resin (B)

The resin (B), i.e., the vinyl polymer, polyester polymer, or polyurethane polymer, is mixed with an aqueous medium to prepare an emulsion of the resin (B). The emulsion of the resin (B) is an aqueous dispersion liquid.

The aqueous medium here refers to a medium containing water as a main component. More specifically, the aqueous medium refers to a medium in which water accounts for 50% by mass or more of the medium. From the aspect of environmental safety, the content rate of water in the aqueous medium is preferably 80% by mass or more, more preferably 90% by mass or more, and most preferably substantially 100% by mass. The aqueous medium may include the following organic solvents other than water: alcohol solvents such as methanol, ethanol, isopropanol, and butanol; ketone solvents such as acetone and methyl ethyl ketone; and ether solvents such as tetrahydrofuran.

The resin (B) may be dispersed in the aqueous medium by dissolving the resin (B) in a ketone solvent, adding a neutralizer thereto to ionize the resin (B), and further adding water thereto, and preferably removing the ketone solvent thereafter, to cause phase inversion.

During this process, the volume average particle diameter of the resin (B) in the emulsion can be adjusted by changing at least one of the following items: stirring force, the amount and type of activator in use, the amount and type of neutralizer in use, and the amount and type of solvent in use. Preferably, the particle diameter is adjusted by changing stirring force. This method does not adversely affect the printed image quality.

The resin (B) in the emulsion has a volume average particle diameter of from 8 to 19 nm.

When the volume average particle diameter of the resin (B) is less than 8 nm, the ink viscosity may increase excessively. In the case in which the resin (B) particles in the ink are too small, when the resulting image is rubbed with a paper sheet, the friction coefficient between the image and the paper sheet may increase to degrade rub resistance of the image. When the volume average particle diameter of the resin (B) is in excess of 19 nm, the resulting image surface may become rough to lower the glossiness, or the resin particles may accumulate on the inner walls of nozzles of an inkjet head to degrade ink discharge stability. The volume average particle diameter of the resin (B) can be measured in the following manner.

First, the emulsion of the resin (B) is diluted with pure water until the resin concentration becomes 0.01% by mass. The diluted emulsion is subjected to a measurement using an instrument MICROTRAC UPA-150 available from Nikkiso Co., Ltd. at 23° C. Here, the volume average particle diameter refers to a 50% average particle diameter (D50).

The above instrument UPA-150 cannot measure the particle diameter of the resin (B) in the ink because of the presence of the pigment in the ink. Therefore, in the case of measuring the particle diameter of the resin (B) in the ink, the ink is frozen and sliced with a frozen specimen preparing apparatus (JFD II EM-19500 available from JEOL Ltd.) to prepare a cross section of the ink. The cross section is carbon-vapor-deposited and washed with distilled water to prepare a carbon replica film. The replica film is observed with a transmission electron microscope (JEM2100-M available from JEOL Ltd.) at an accelerating voltage of 200 kV to measure the particle diameter of the resin (B).

### Aliphatic Diol

The ink preferably includes an aliphatic dial having an unsaturated bond in an amount of from 0.05% to 0.07% by mass, more preferably from 0.05% to 0.25% by mass. The resin (B) in the ink may gradually adhere to the inner walls of nozzles as the ink is continuously discharged from the head. As the resin (B) gradually accumulates on the wall surfaces, the ink cannot be normally discharged from the nozzles. Specifically, the discharge speed of ink droplet may change, the discharge path of ink droplet may bend, or the resulting image quality may deteriorate due to the increase of satellite droplets. The inventors of the present invention have found that when the ink includes an aliphatic alcohol having an unsaturated bond, adherence of the resin (B) to the wall surfaces of the nozzles is suppressed. Although the mechanism is still unclear, the inventors are assuming that the aliphatic alcohol having an unsaturated bond exerts a releasing effect.

When the content is 0.05% by mass or more, the aliphatic diol having an unsaturated bond effectively exerts its releasing function, thereby suppressing adherence of the resin (B) to the inner walls of the nozzles and improving ink discharge stability. When the content is 07% by mass or less, the resin (B) and pigment can be stably dispersed in the ink, thereby improving ink discharge stability without changing wettability of ink droplet.

### Water-Soluble Organic Solvent

The ink further includes a water-soluble organic solvent. The water-soluble organic solvent preferably includes a water-soluble organic solvent (G) having a boiling point of from 280° C. to 300° C. and at least one of a water-soluble organic solvent (X) having a boiling point of from 180° C. to 190° C. and a water-soluble organic solvent (Y) having a boiling point of from 190° C. to 200° C.

The ink includes the resin emulsion for improving rub resistance and glossiness of the resulting image, as described above. As such an ink containing the resin emulsion is dried, the resin easily forms its film at the meniscus part of nozzles to degrade maintainability of printer. To prevent this phenomenon and improve maintainability of printer, it is possible to include a high-boiling-point solvent to the ink to make the ink be much harder to dry. However, this solution also reduces drying property of the resulting image. Thus, the ink may disadvantageously cause offset phenomenon when the printed image is brought into contact with a conveyance roller immediately after being printed, or blocking phenomenon when the printed images are stacked and loaded on one another immediately after being printed.

When the water-soluble organic solvent includes the water-soluble organic solvent (G) having a boiling point of from 280° C. to 300° C. and the water-soluble organic solvent (X) having a boiling point of from 180° C. to 190° C. and/or the water-soluble organic solvent (Y) having a boiling point of from 190° C. to 200° C., maintainability of printer and drying property of the resulting image go together.

The water-soluble organic solvents (X) and (Y) each having a boiling point of 200° C. or less contribute to improvement in drying property of the printed images. The water-soluble organic solvent (G) having a boiling point of 280° or more contributes to improvement in maintainability of printer.

The water-soluble organic solvents (X) and (Y) are preferably used in combination, rather than being used alone, so that the ink exerts desired ink properties. When the water-soluble organic solvent (X) is used alone, the content thereof in the ink is so large that drying property and discharge stability may deteriorate. When the water-soluble organic solvent (Y) is used alone, temporal stability of the ink may deteriorate. When the water-soluble organic solvents (X) and (Y) are used in combination, the resulting image is given a good color developing property.

The content rate of the water-soluble organic solvent (X) in the ink is preferably in the range of from 24% to 40% by mass. When the content rate of the water-soluble organic solvent (X) is 24% by mass or more, the ink is less likely to undergo thickening inside nozzles, thereby improving maintainability of printer. When the content rate of the water-soluble organic solvent (X) is 40% by mass or less, drying property improves. When the ratio(X/Y) of the water-soluble organic solvent (X) to the water-soluble organic solvent (Y) is less than 2, the combined effect of two water-soluble organic solvents is small. When the ratio (X/Y) is greater than 20, the pigment dispersed in the ink becomes less stable to degrade temporal stability of the ink. When the total content rate (X+Y) of the water-soluble organic solvent (X) and the water-soluble organic solvent (Y) is 30% by mass or more, maintainability of printer improves. When the total content rate (X+Y) is 42% by mass or less, drying property improves.

Specific examples of the water-soluble organic solvent (X) having a boiling point of from 180° C. to 190° C. include, but are not limited to, 2,3-butanediol (having a boiling point of 182° C.), propylene glycol (having a boiling point of 188° C.), and diethylene glycol diethyl ether (having a boiling point of 189° C.). Specific examples of the water-soluble organic solvent (Y) having a boiling point of from 190° C. to 200° C. include, but are not limited to, 1,2-butanediol (having a boiling point of 193° C.), diethylene glycol monomethyl ether (having a boiling point of 194° C.), and 2-methyl-2,4-pentanediol (having a boiling point of 198° C.).

The content rate of the water-soluble organic solvent (G) having a boiling point of from 280° C. to 300° C. in the ink is preferably in the range of from 2% to 6% by mass, for improving maintainability of printer. Specific examples of the water-soluble organic solvent (G) having a boiling point of from 280° C. to 300° C. include, but are not limited to, glycerin (having a boiling point of 290° C.).

When the content rate of the water-soluble organic solvent (G) is 2% by mass or more, maintainability of printer improves. When the content rate of the water-soluble organic solvent (G) is 6% by mass or less, drying property of the resulting image improves.

### Wetting Agent

The ink may further include a wetting agent along with the water-soluble organic solvent. Examples of the wetting agent include urea compounds and sugars. Specific examples of the sugars include, but are not limited to, monosaccharides, disaccharides, oligosaccharides (including trisaccharides and tetrasaccharides), and polysaccharides, such as glucose, mannose, fructose, ribose, xylose, arabinose, galactose, maltose, cellobiose, lactose, sucrose, trehalose, and maltotriose. Here, the polysaccharides refer to sugar in abroad sense, including substances existing widely in nature, such as α-cyclodextrin and cellulose.

Specific examples of the sugars further include sugar derivatives such as reducing sugars (e.g., a sugar alcohol represented by the general formula HOCH₂(CHOH)ₙCH₂OH, wherein n represents an integer of from 2 to 5), oxidized sugars (e.g., aldonic acid, uronic acid), amino acid, and thio acid. Among these sugar derivatives, sugar alcohols are preferable. Specific examples of the sugar alcohols include, but are not limited to, D-sorbitol, sorbitan, maltitol, erythritol, lactitol, and xylitol.

### Water

The water contained in the ink may be pure water such as ion-exchange water, ultrafiltration water, reverse osmosis water, and distilled water, or ultrapure water.

The content rate of the water in the ink is not limited to a specific value.

### Colorant

Examples of the colorant include inorganic pigments and organic pigments.

Specific examples of the inorganic pigments include, but are not limited to, titanium oxide, iron oxide, calcium carbonate, barium sulfate, aluminum hydroxide, barium yellow, cadmium red, chrome yellow, and carbon black. Among these inorganic pigments, carbon black is preferable. Specifically, carbon black produced by a known method, such as a contact method, a furnace method, and a thermal method, can be used.

Specific examples of the organic pigments include, but are not limited to, azo pigments, polycyclic pigments, nitro pigments, nitroso pigments, and aniline black. Among these organic pigments, azo pigments and polycyclic pigments are preferable.

Specific examples of the azo pigments include, but are not limited to, azo lakes, insoluble azo pigments, condensed azo pigments, and chelate azo pigments.

Specific examples of the polycyclic pigments include, but are not limited to, phthalocyanine pigments, perylene pigments, perinone pigments, anthraquinone pigments, quinacridone pigments, dioxazine pigments, indigo pigments, thioindigo pigments, isoindolinone pigments, and quinophthalone pigments.

The colorant is not limited in its color. Any colorant used for black-and-white printing or color printing can be used. Each of the above-described colorants can be used alone or in combination with others.

Specific examples of colorants usable for black-and-white printing include, but are not limited to: carbon blacks (i.e., C.I. Pigment Black 7) such as furnace black, lamp black, acetylene black, and channel black; metals such as copper, iron (i.e., C.I. Pigment Black 11), and titanium oxide; and organic pigments such as aniline black (i.e., C.I. Pigment Black 1).

Specifically, a carbon black which is produced by a furnace method or a channel method and has a primary particle diameter of from 15 to 40 nm, a BET specific surface area of from 50 to 300 m²/g, a DBP oil absorption of from 40 to 150 ml/100 g, a volatile content of from 0.5% to 10%, and a pH value of from 2 to 9 is preferable.

Specific examples of such a carbon black include, but are not limited to: No. 2300, No. 900, MCF-88, No. 33, No. 40, No. 45, No. 52, MA7, MA8, MA100, No. 2200B (available from Mitsubishi Chemical Corporation); RAVEN 700, 5750, 5250, 5000, 3500, and 1255 (available from Columbian Chemicals); REGAL 400R, 330R, and 660R, MOGUL L, and MONARCH 700, 800, 880, 900, 1000, 1100, 1300, and 1400 (available from Cabot Corporation); and COLOR BLACK FW1, FW2, FW2V, FW18, FW200, S 150, S 160, and S170, PRINTEX 35, U, V, 140U, 140V, and SPECIAL BLACK 6, 5, 4A, and 4 (available from Degussa AG).

Specific examples of pigments usable for yellow ink include, but are not limited to, C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 114, C.I. Pigment Yellow 120, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 174, and C.I. Pigment Yellow 180.

Specific examples of pigments usable for magenta ink include, but are not limited to, C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 146, C.I. Pigment Red 168, C.I. Pigment Red 176, C.I. Pigment Red 184, C.I. Pigment Red 185, C.I. Pigment Red 202, and C.I. Pigment Violet 19.

Specific examples of pigments usable for cyan ink include, but are not limited to, C.I. Pigment Blue |, Cl Pigment Blue 2, C.I. Pigment Blue 3, C.I. Pigment Blue |5, Cl Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Pigment Blue 63, C.I. Pigment Blue 66, C.I. Vat Blue 4, and C.I. Vat Blue 60.

Not only the above-described pigments, but also any new pigment exclusively produced for the present invention can be used.

When C.I. Pigment Yellow 74 is used as the yellow pigment, C.I. Pigment Red 122 and C.I. Pigment Violet 19 are used as the magenta pigment, and C.I. Pigment Blue 15 is used as the cyan pigment, the resulting ink can achieve a good balance between color tone and light resistance.

The content rate of the pigment in the ink is preferably in the range of from 0.1% to 50.0% by mass, more preferably from 0.1% to 20.0% by mass.

The pigment preferably has an average particle diameter (D50) of 150 nm or less, more preferably 100 nm or less. Here, the average particle diameter (D50) refers to an average particle diameter measured by a dynamic light scattering method using an instrument MICROTRAC UPA-150 (available from Nikkiso Co., Ltd.) under an environmental condition 23° C., 55% RH. When the pigment has such an average particle diameter (D50), the resulting image has a wiiform density since the occurrence of diffuse reflection of light is suppressed in the image.

### Surfactant

The ink may optionally include a surfactant. A surfactant which provides constant dispersion stability regardless of the types of colorant and/or water-soluble organic solvent (wetting agent) in use, as well as low surface tension, high permeability, and high leveling property, is preferable. Examples of the surfactant include anionic surfactants, nonionic surfactants, silicone-based surfactants, fluorine-based surfactants, and mixtures thereof. Among these surfactants, silicone-based surfactants and fluorine-based surfactants are preferable.

The fluorine-based surfactant preferably includes 2 to 16 fluorine-substituted carbon atoms, more preferably 4 to 16 fluorine-substituted carbon atoms. When the number of fluorine-substituted carbon atoms is less than 2, fluorine cannot exert its effect. When the number of fluorine-substituted carbon atoms is in excess of 16, ink storage stability may deteriorate.

Specific examples of the fluorine-based surfactants include, but are not limited to, perfluoroalkyl sulfonic acid compounds, perfluoroalkyl carboxylic acid compounds, perfluoroalkyl phosphate compounds, perfluoroalkyl ethylene oxide adducts, and polyoxyalkylene ether polymer compounds having a perfluoroalkyl ether group on side chain. Among these surfactants, polyoxyalkylene ether polymer compounds having a perfluoroalkyl ether group on side chain is preferable since foaming properly thereof is small.

The fluorine-based surfactant represented by the following formula is more preferably used.

CF₃CF₂(CF₂CF₂)ₘ—CH₂CH₂O(CH₂CH₂O)ₙH

In the above formula, m represents an integer of from 0 to 10 and n represents an integer of from 1 to 40.

Specific examples of the perfluoroalkyl sulfonic acid compounds include, but are not limited to, perfluoroalkyl sulfonic acid and perfluoroalkyl sulfonate.

Specific examples of the perfluoroalkyl carboxylic acid compounds include, but are not limited to, perfluoroalkyl carboxylic acid and perfluoroalkyl carboxylate.

Specific examples of the perfluoroalkyl phosphate compounds include, but are not limited to, perfluoroalkyl phosphate and perfluoroalkyl phosphate salt.

Specific examples of the polyoxyalkylene ether polymer compounds having a perfluoroalkyl ether group on side chain include, but are not limited to, polyoxyalkylene ether polymer having a perfluoroalkyl ether group on side chain, sulfate of polyoxyalkylene ether polymer having a perfluoroalkyl ether group on side chain, and a salt of polyoxyalkylene ether polymer having a perfluoroalkyl ether group on side chain.

Specific examples of the counter ions for these fluorine-based surfactants include, but are not limited to, Li, Na, K, NH₄, NH₃CH₂CH₂OH, NH₂(CH₂CH₂OH)₂, and NH(CH₂CH₂OH)₃.

The fluorine-based surfactants are available either synthetically or commercially.

Specific examples of commercially-available fluorine-based surfactants include, but are not limited to: SURFLON S-111, S-112, S-113, S-121, S-131, S-132, S-141, and S-145 (available from AGC Seimi Chemical Co., Ltd.); Fluorad^{TM} FC-93, FC-95, FC-98, FC-129, FC-135, FC-170C, FC-430, and FC-431 (available from 3M); MEGAFACE F-470, F-1405, and F-474 (available from DIC Corporation); Zonyl® TBS, FSP, FSA, FSN-100, FSN, FSO-100, FSO, FS-300, and UR (available from E. I. du Pont de Nemours and Company); FT-110, FT-250, FT-251, FT-400S, FT-150, and FT-400SW (available from NEOS COMPANY LIMITED); and PolyFox PF-151N (available from OMNOVA Solutions Inc.). Among these surfactants, FS-300 (available from E. I. du Pont de Nemours and Company), FT-110, FT-250, FT-251, FT-400S, FT-150, and FT-400SW (available from NEOS COMPANY LIMITED), and PolyFox PF-151N (available from OMNOVA Solutions Inc.) are preferable since they can drastically improve print quality, particularly color developing property and level dying property for paper.

Specific preferred examples of the fluorine-based surfactants include anionic, nonionic, ampholytic, or oligomer fluorine-based surfactants represented by the following formulae (2) to (10).

### (A) Anionic Fluorine-Based Surfactants

Preferred examples of anionic fluorine-based surfactants are represented by any one of the following formulae (2) to (5).

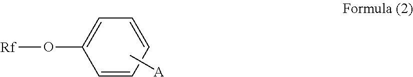

In Formula (2), Rf represents a mixture of fluorine-containing hydrophobic groups represented by the following formulae (i) and (ii), and A represents —SO₃X, —COOX, or —PO₃X, where X represents a counter anion such as hydrogen atom, Li, Na, K, NH₃CH₂CH₂OH, NH₂(CH₂CH₂OH)₂, and NH(CH₂CH₂OH)₃.

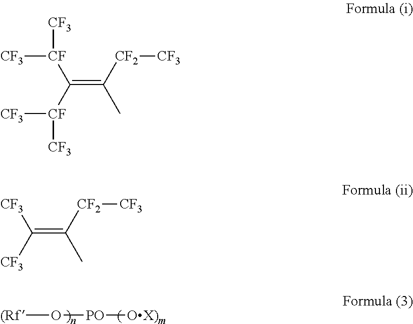

In Formula (3), Rf′ represents a fluorine-containing group represented by the following formula (iii), X represents the same thing as that in Formula (2), n represents an integer of 1 or 2, and m represents 2−n.

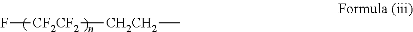

In Formula (iii), n represents an integer of from 3 to 10.

Rf′-S—CH₂CH₂—COO.X Formula (4)

In Formula (4), Rf′ and X each represent the same things as those in Formula (3).

Rf′-SO₃.X Formula (5)

In Formula (5), Rf′ and X each represent the same things as those in Formula (3).

### (B) Nonionic Fluorine-Based Surfactants

Preferred examples of nonionic fluorine-based surfactants are represented by the following formula (6) or (7).

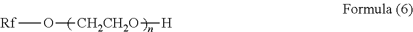

In Formula (6), Rf represents the same thing as that in Formula (2), and n represents an integer of from 5 to 20.

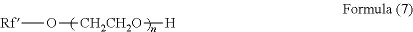

In Formula (7), Rf′ represents the same thing as that in Formula (3), and n represents an integer of from 1 to 40.

### (C) Ampholytic Fluorine-Based Surfactants

Preferred examples of ampholytic fluorine-based surfactants are represented by the following formula (8).

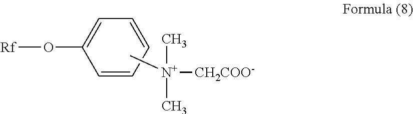

In Formula (8), Rf represents the same thing as that in Formula (2).

### (D) Oligomer Fluorine-Based Surfactants

Preferred examples of oligomer fluorine-based surfactants are represented by the following formula (9) or (10).

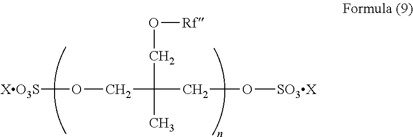

In Formula (9), Rf″ represents a fluorine-containing group represented by the following formula (iv), n represents an integer of from 0 to 10, and X represents the same thing as that in Formula (2).

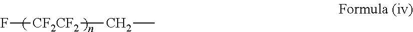

In Formula (iv), n represents an integer of from 1 to 4.

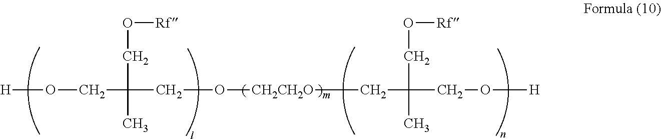

In Formula (10), Rf″ represents the same thing as that in Formula (9), l represents an integer of from 0 to 10, m represents an integer of from 0 to 10, and n represents an integer of from 0 to 10.

Specific preferred examples of the silicone-based surfactants include those indecomposable at high pH, such as side-chain-modified polydimethylsiloxane, both-terminals-modified polydimethylsiloxane, one-terminal-modified polydimethylsiloxane, and side-chain-and-both-terminals-modified polydimethylsiloxane. More specifically, a polyether-modified silicone-based surfactant having polyoxyethylene group and/or polyoxyethylene polyoxypropylene group as modifying groups is more preferable since it exhibits good properties as an aqueous surfactant.

These surfactants are available either synthetically or commercially.

Commercial products are readily available from BYK Japan KK, Shin-Etsu Silicone (Shin-Etsu Chemical Co., Ltd.), and Dow Corning Toray Co., Ltd.

Specific examples of the polyether-modified silicone-based surfactant include, but are not limited to, a compound represented by the following formula (11) that is a dimethylpolysiloxane having a side chain having a polyalkylene oxide structure, bonded to Si atom.

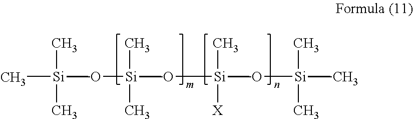

X═—R(C₂H₄O)a(C₃H₆O)bR′

In Formula (11), each of m, n, a, and b independently represents an integer, and R and R′ independently represents an alkyl group or an alkylene group.

Specific examples of commercially-available polyether-modified silicone-based surfactants include, but are not limited to, KF-618, KF-642, and KF-643 (available from Shin-Etsu Chemical Co., Ltd.).

Specific examples of the anionic surfactants include, but are not limited to, acetate, dodecylbenzene sulfonate, and laurate of polyoxyethylene alkyl ether, and polyoxyethylene alkyl ether sulfate. Specific examples of the nonionic surfactants include, but are not limited to, polyoxyethylene alkyl ether, polyoxypropylene polyoxyethylene alkyl ether, polyoxyethylene alkyl ester, polyoxyethylene sorbitan fatty acid ester, polyoxyethylene alkyl phenyl ether, polyoxyethylene alkyl amine, and polyoxypropylene alkyl amide.

The content rate of the surfactant in the ink is preferably in the range of from 0.01% to 3.0% by mass, more preferably from 0.5% to 2% by mass. When the content of the surfactant is less than 0.01% by mass, the surfactant may not exert its effect. When the content of the surfactant is in excess of 3.0% by mass, ink permeability to recording media may excessively increase to cause image density reduction and strike-through.

### Penetrant

The ink preferably includes a penetrant. The penetrant preferably includes at least one polyol compound having 8 to 11 carbon atoms. Specifically, such a polyol compound having a water solubility in the range of from 0.2% to 5.0% by mass at 25° C. is preferable. More specifically, 2-ethyl-1,3-hexanediol (having a solubility of 4.2% at 25° C.) and 2,2,4-trimethyl-1,3-pentanediol (having a solubility of 2.0% at 25° C.) are preferable.

Specific preferred examples of the polyol compound further include, but are not limited to, aliphatic dials such as 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, and 5-hexene-1,2-diol.

The polyol compound can be used in combination with another penetrant which is soluble in the ink to control properties of the ink. Specific examples of such penetrant include, but are not limited to: alkyl and allyl ethers of polyols, such as diethylene glycol monophenyl ether, ethylene glycol monophenyl ether, ethylene glycol monoallyl ether, diethylene glycol monophenyl ether, diethylene glycol monobutyl ether, propylene glycol monobutyl ether, and tetraethylene glycol chlorophenyl ether; and lower alcohols such as ethanol.

The content rate of the penetrant in the ink is preferably in the range of from 0.1% to 4.0% by mass. When the content of the penetrant is less than 0.1% by mass, the resulting image may blur without being quickly dried. When the content of the penetrant is in excess of 4.0% by mass, dispersion stability of the colorant may deteriorate, nozzle clogging may easily occur, or ink permeability to recording media may excessively increase to cause image density reduction and strike-through.

### Other Components

The ink may further include other components such as a defoamer, a pH adjuster, an antiseptic antifungal agent, a chelate agent, an antirust, an antioxidant, an ultraviolet absorber, an oxygen absorber, and/or, a photostabilizer, if needed.

Specific examples of the defoamer include, but are not limited to, silicone defoamers, polyether defoamers, and fatty acid ester defoamers. Each of these defoamers can be used alone or in combination with others. Among these defoamers, silicone defoamers, having excellent defoaming ability, are preferable.

The pH adjuster is not limited to a specific material so long as it can adjust the pH of the ink to within the range of from 7 to 11 without adversely affecting the ink. Specific examples of the pH adjuster include, but are not limited to, alcohol amines, alkali metal hydroxides, ammonium hydroxides, phosphonium hydroxides, and alkali metal carbonates. When the pH is less than 7 or in excess of 11, inkjet head and/or ink supply unit may be dissolved out in large amounts, thereby causing alternation, leakage, and defective discharge of the ink.

Specific examples of the alcohol amines include, but are not limited to, diethanolamine, triethanolamine, and 2-amino-2-ethyl-1,3-propanediol.

Specific examples of the alkali metal hydroxides include, but are not limited to, lithium hydroxide, sodium hydroxide, and potassium hydroxide.

Specific examples of the ammonium hydroxides include, but are not limited to, ammonium hydroxide and quaternary ammonium hydroxide. Specific examples of the phosphonium hydroxides include, but are not limited to, quaternary phosphonium hydroxide.

Specific examples of the alkali metal carbonates include, but are not limited to, lithium carbonate, sodium carbonate, and potassium carbonate.

Specific examples of the antiseptic antifungal agent include, but are not limited to, sodium dehydroacetate, sodium sorbate, 2-pyridinethiol-1-oxide sodium, sodium benzoate, and pentachlorophenol sodium.

Specific examples of the chelate agent include, but are not limited to, ethylenediaminetetraacetic acid tetrasodium salt, nitrilotriacetic acid trisodium salt, hydroxyethylethylenediaminetriacetic acid trisodium salt, diethylenetriaminepentaacetic acid pentasodium salt, and uramildiacetic acid disodium salt.

Specific examples of the antirust include, but are not limited to, acid sulphite, sodium thiosulfate, ammonium thiodiglycolate, diisopropylammonium nitrite, pentaerythritol tetranitrate, and dicyclohexlyammonium nitrite.

Specific examples of the antioxidant include, but are not limited to, phenol-based antioxidants (including hindered-phenol-based antioxidants), amine-based antioxidants, sulfur-based antioxidants, and phosphor-based antioxidants.

Specific examples of the phenol-based antioxidants (including hindered-phenol-based antioxidants) include, but are not limited to, butylated hydroxyanisole, 2,6-di-tert-butyl-4-ethylphenol, stearyl-β-(3,5-di-tert-butyl-4-hydroxyphenyl)propionate, 2,2′-methylenebis(4-methyl-6-tert-butylphenol), 2,2′-methylenebis(4-ethyl-6-tert-butylphenol), 4,4′-butylidenebis(3-metliyl-6-tert-butylphenol), 3,9-bis[1,1-dimethyl-2-[β-(3-tert-butyl-4-hydroxy-5-methylphenyl)propionyloxy]ethyl]2,4,8,10-tetrakisspiro[5,5]undecane, 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, and tetralcisimethylene-3-(3′,5′-di-tert-butyl-4′-hydroxyphenyl)propionate]methane.

Specific examples of the amine-based antioxidants include, but are not limited to, phenyl-β-naphthylamine, α-naphthylamine, N,N′-di-sec-butyl-p-phenylenediamine, phenothiazine, N,N′-diphenyl-p-phenylenediamine, 2,6-di-tert-butyl-p-cresol, 2,6-di-tert-butylphenol, 2,4-dimethyl-6-tert-butyl-phenol, butyl hydroxyanisole, 2,2′-methylenebis(4-methyl-6-tert-butylphenol),4,4′-butylidenebis(3-methyl-6-tert-butylphenol), 4,4′-thiobis(3-methyl-6-tert-butylphenol), tetrakis[methylene-3(3,5-di-tert-butyl-4-hydroxyphenyl)propionate]methane, and 1,1,3-tris(2-methyl-4-hydroxy-5-tert-butylphenyl)butane.

Specific examples of the sulfur-based antioxidants include, but are not limited to, dilauryl 3,3′-thiodipropionate, distearyl thiodipropionate, lauryl stearyl thiodipropionate, dimyristyl 3,3′-thiodipropionate, distearyl β,β′-thiodipropionate, 2-mercaptobenzimidazole, and dilauryl sulfide.

Specific examples of the phosphor-based antioxidants include, but are not limited to, triphenyl phosphite, octadecyl phosphite, triisodecyl phosphite, trilauryl trithiophosphite, and trinonyl phenyl phosphite.

Specific examples of the ultraviolet absorber include, but are not limited to, benzophenone-based ultraviolet absorbers, benzotriazole-based ultraviolet absorbers, salicylate-based ultraviolet absorbers, cyanoacrylate-based ultraviolet absorbers, and nickel-complex-salt-based ultraviolet absorbers.

Specific examples of the benzophenone-based ultraviolet absorbers include, but are not limited to, 2-hydroxy-4-n-octoxybenzophenone, 2-hydroxy-4-n-dodecyloxybenzophenone, 2,4-dihydroxybenzophenone, 2-hydroxy-4-methoxybenzophenone, and 2,2′,4,4′-tetrahydroxybenzophenone.

Specific examples of the benzotriazole-based ultraviolet absorbers include, but are not limited to, 2-(2′-hydroxy-5′-tert-octylphenyl)benzotriazole, 2-(2′-hydroxy-5′-methylphenyl)benzotriazole, 2-(2′-hydroxy-4′-octoxyphenyl)benzotriazole, and 2-(2′-hydroxy-3′-tert-butyl-5′-methylphenyl)-5-chlorobenzotriazole.

Specific examples of the salicylate-based ultraviolet absorbers include, but are not limited to, phenyl salicylate, p-tert-butylphenyl salicylate, and p-octylphenyl salicylate.

Specific examples of the cyanoacrylate-based ultraviolet absorbers include, but are not limited to, ethyl-2-cyano-3,3′-diphenyl acrylate, methyl-2-cyano-3-methyl-3-(p-methoxyphenyl)acrylate, and butyl-2-cyano-3-methyl-3-(p-methoxyphenyl)acrylate.

Specific examples of the nickel-complex-salt-based ultraviolet absorbers include, but are not limited to, nickel bis(octylphenyl)sulfide, 2,2′-thiobis(4-tert-octyl ferrate)-n-butylamine nickel (II), 2,2′-thiobis(4-tert-octyl ferrate)-2-ethylhexylamine nickel (II), and 2,2′-thiobis(4-tert-octyl ferrate) triethanolamine nickel (II).

### Ink Production Method

The ink is produced by dispersing or dissolving the water-soluble organic solvent (wetting agent) and water, optionally along with the penetrant, the surfactant, and other components, in an aqueous medium, and mixing the resin emulsion and the resin-coated pigment dispersion liquid therein. The dispersing may be performed by sand mill, homogenizer, ball mill, paint shaker, ultrasonic disperser. The mixing may be performed by a stirrer equipped with stirring blades, magnetic stirrer, or high-speed disperser.

### Ink Properties

The ink is not limited in properties such as viscosity, surface tension, and pH. Preferably, the ink has a viscosity in the range of from 5 to 25 mPa·s at 25° C. When the ink viscosity is 5 mPa·s or more, print density and text quality are improved. When the ink viscosity is 25 mPa·s is less, discharge stability is secured.

The viscosity can be measured by a viscometer (e.g., RE-550L available from Toki Sangyo Co., Ltd.) at 25° C.

Preferably, the ink has a surface tension of 35 mN/m or less, more preferably 32 mN/m or less, at 25° C. When the surface tension is in excess of 35 mN/m, the ink hardly levels on recording media to cause elongation of the drying time.

Preferably, the ink has a pH of from 7 to 12, more preferably 8 to 11, to prevent corrosion of metallic members in contact with the ink.

### Ink Set

The ink is not limited in its color, and may have any color such as yellow, magenta, cyan, and black. An ink set including two or more inks having different colors can form multi-color images. An ink set including inks having yellow, magenta, cyan, and black colors can form full-color images.

### Ink Cartridge

An ink cartridge according to an embodiment of the present invention includes a container and the ink contained in the container, and optionally includes other members.

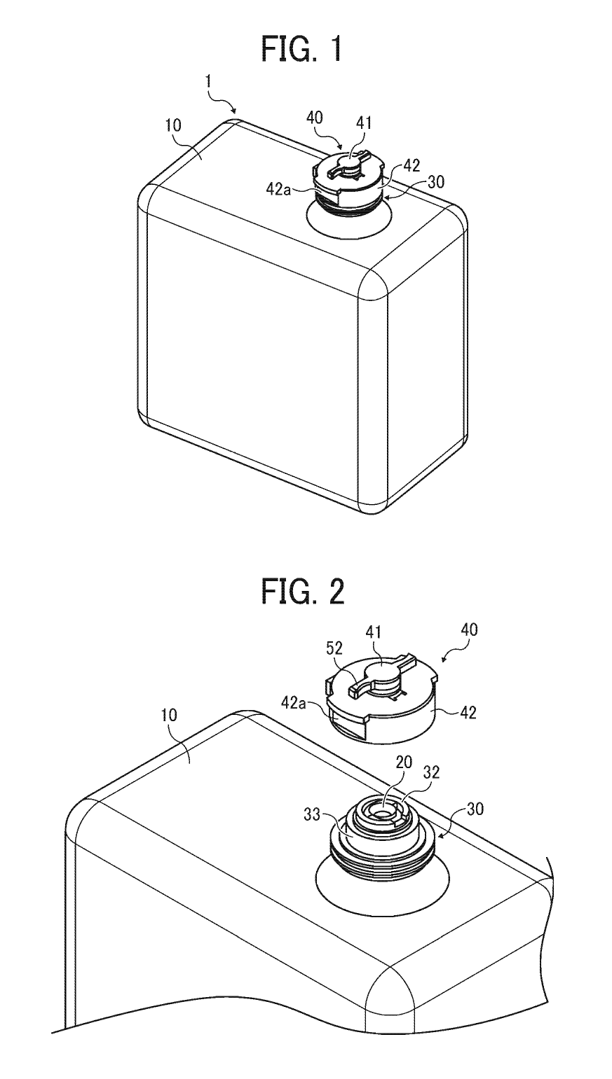

The ink cartridge according to an embodiment of the present invention is described below with reference to FIGS. 1 to 3.

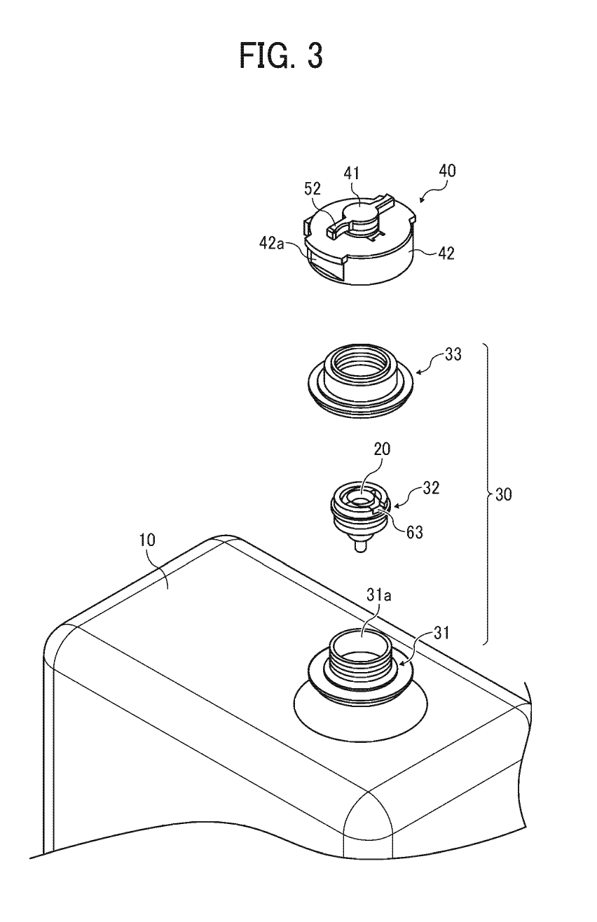

FIG. 1 is a perspective view of an ink cartridge. FIG. 2 is a perspective view of an ink supply opening of the ink cartridge before being fitted with a cap. FIG. 3 is an exploded perspective view of the ink supply opening.

An ink cartridge 1 includes an ink container 10 containing the ink. The ink container 10 has an ink supply opening part 30. The ink supply opening part 30 has an ink supply opening 20 for supplying the ink outside. The ink container 10 has a cap 40 for covering the ink supply opening part 30.

The ink supply opening part 30 includes an opening member 31, a rotation regulator 32, and a securing member 33. The opening member 31 is secured to the ink container 10. The rotation regulator 32 is disposed inside an opening part 31a of the opening member 31. The ink supply opening 20 is formed on the rotation regulator 32. The securing member 33 secures the rotation regulator 32 inside the opening part 31a of the opening member 31 of the ink container 10. The cap 40 is fitted with the securing member 33.

The ink supply opening 20 formed on the rotation regulator 32 is in communication with an ink containing member in the ink container 10 through a tube.

In the present embodiment, the ink supply opening part 30 is formed by combining independent members, i.e., the opening member 31, the rotation regulator 32, and the securing member 33. Alternatively, the opening member 31, the rotation regulator 32, and the securing member 33 may be integrally molded to become a single member. Alternatively, these members may also be integrally molded together with the ink container 10.

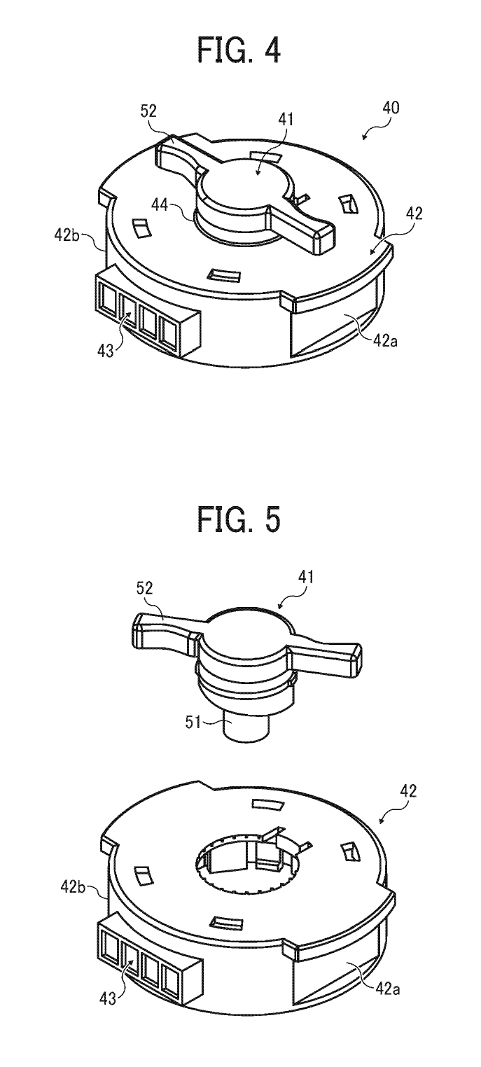

Details of the cap 40 are described below with reference to FIGS. 4 and 5. FIGS. 4 and 5 are perspective views of the cap 40 in an initial state and a separated state, respectively. The cap 40 includes a sealer 41 and a holder 42. The sealer 41 seals the ink supply opening 20 of the ink supply opening part 30. The holder 42 holds an integrated circuit (IC) chip 43 serving as an information storage for storing information on the ink. The sealer 41 and the holder 42 are connected to each other in a separable manner via multiple bridge parts 44. The bridge parts 44 are breakable parts formed between the outer peripheral surface of the sealer 41 and the inner peripheral surface of the holder 42. As the sealer 41 is rotated relative to the holder 42, the bridge parts 44 are broken to separate the sealer 41 from the holder 42.

The sealer 41 has a plug part 51 and a lever part 52. The plug part 51, in the form of a column, is to be inserted into the ink supply opening 20 to close the ink supply opening 20. The lever part 52 is extending in a direction perpendicular to the ink supply direction. The holder 42 has guide receiving surfaces 42a and 42b on opposite positions on the outer peripheral surface thereof. The guide receiving surfaces 42a and 42b are brought into contact with guide members of an apparatus body (printer body) along the direction of loading of the ink cartridge 1 to the apparatus body.

During transportation of the ink cartridge 1, the cap 40 is fitted with the ink supply opening part 30 so that the plug part 51 of the sealer 41 is inserted into the ink supply opening 20 to close the ink supply opening 20. As the sealer 41 is secured to the ink supply opening part 30, the holder 42 is also secured to the ink supply opening part 30 through the sealer 41. During loading of the ink cartridge 1 to the apparatus body, as the lever part 52 is rotated to rotate the sealer 41, the bridge parts 44 between the sealer 41 and the holder 42 are broken to allow the sealer 41 to separate from the holder 42. As the plug part 51 is removed from the ink supply opening 20, the ink supply opening 20 is opened.

### Recording Medium

Specific examples of the recording medium include, but are not limited to, plain paper, glossy paper, special paper, clothes, film, overhead projector (OHP) transparency, and general-purpose printing paper. Each of these recording media can be used alone or in combination with others.

Preferably, the recording medium is coated paper. Generally, coated paper is inferior to plain paper in terms of ink absorptivity. Therefore, when coated paper is used for inkjet printing, a dryer is used in combination, but there still exists a problem of poor drying property of the resulting image. On the other hand, the ink according to an embodiment of the present invention provides an image having good drying property even when the image is printed on coated paper.

Specific examples of commercially-available coated papers include, but are not limited to: OK TOP COAT, OK ASTROGLOSS, OK NONWRINKLE, SA KINFUJI+, OK KINFUJI+, OK NONWRINKLE, (F)MCOP, OK ASTRODULL, OK ASTROMAT, OK ULTRA AQUA SATIN, OK EMBOSS KINUME, OK EMBOSS NASHIJI, OK EMBOSS NUNOME, OK EMBOSS HOMESPUN, OK OPTOGLOSS, OK KASAO, OK CASABLANCA, OK CASABLANCA-V, OK CASABLANCA-X, OK KINFUJI ONE-SIDE ART, OK COAT L, OK COAT L GREEN 100, OK COAT N GREEN 100, OK COAT V, OK MEDIUM QUALITY COAT (OFFSET USE), OK TOP COAT S, OK TOP COAT DULL, OK TOP COAT MAT N, OK TRINITY, OK TRINITY NAVI, OK TRINITY NAVI-V, OK NEO TOP COAT, OK NEO TOP COAT MAT, OK NONWRINKLE AL, OK NONWRINKLE DL, OK NONWRINKLE BL, OK WHITE L, OK MAT COAT L GREEN 100, OK MAT COAT GREEN 100, OK ROYAL COAT, Z COAT, Z COAT GREEN 100, ULTRASAT1N KINFUJI N, GOLDEN MAT, SATIN KINFUJI N, NEW AGE, NEW AGE GREEN 100, MIRROR COAT GOLD, MIRROR COAT PLATINUM, ROYAL COAT L, LOSSTONE COLOR, POD SUPERGLOSS, POD GLOSS COAT, and POD MAT COAT (available from Oji Paper Co., Ltd.); BROAD MAT A, BROAD GLOSS A, WHITE PEARL COAT N, NEW V MAT, PEARL COAT, DIGNITY, VISTA GLOSS, N PEARL COAT, UTRILLO, EP-D GLOSS, EP-L GLOSS, EP-L MAT, EP-D PREMIUM WHITE, and EP SUPER HIGH QUALITY (available from Mitsubishi Paper Mills Limited); Hi-a, α MAT, KINMARI Hi-L, μ COAT, μ MAT, and μ WHITE (available from Hokuetsu Kishu Paper Co., Ltd.); and LUMI ART GLOSS PAPER (available from Stora Enso).

Among these products, LUMI ART GLOSS PAPER is preferable. When LUMI ART GLOSS PAPER is used in combination with a known inkjet ink, the resulting image may have poor drying property due to its low ink absorptivity. By contrast, when this paper is used in combination with the ink according to an embodiment of the present invention, the resulting image can obtain excellent drying property.

### Inkjet Recording Apparatus

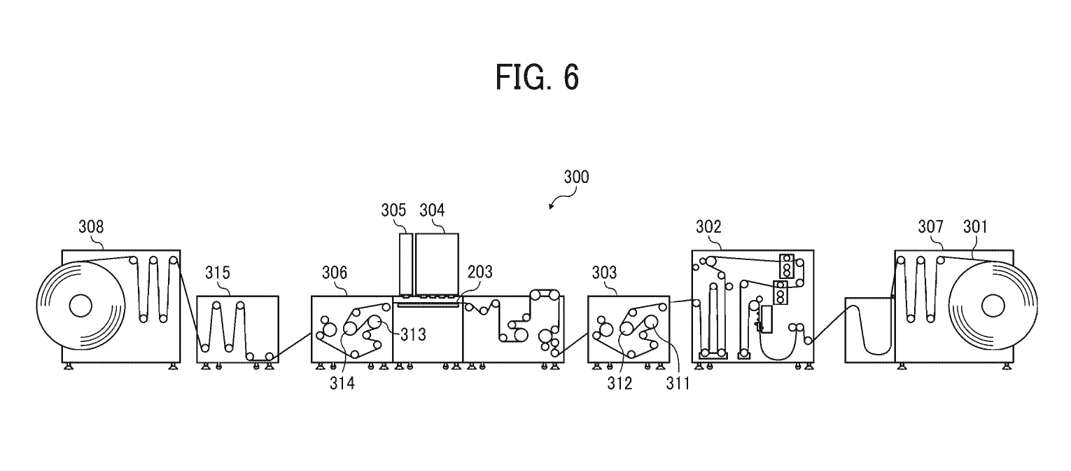

FIG. 6 is a schematic view of an inkjet recording apparatus according to an embodiment of the present invention. An inkjet recording apparatus 300 includes a recording medium conveyer 301, a pretreatment part 302 in which a pretreatment liquid is applied to a recording medium 203, an image forming part 304, and an aftertreatment part 305 in which an aftertreatment liquid is applied to the recording medium having an image formed at the image forming part 304 thereon.

The recording medium conveyer 301 includes a sheet feeder 307, multiple conveyance rollers, and a winder 308. In FIG. 6, the recording medium 203 is in the form of continuous paper (rolled paper). The recording medium 203 is wound off from the sheet feeder 307 by the conveyance roller, conveyed on a platen, and winded up by the winder 308.

In the pretreatment part 302, a pretreatment liquid is applied to the recording medium 203 conveyed by the recording medium conveyer 301. Generally, if a recording medium other than paper exclusively for inkjet printing is used for inkjet image forming apparatus, various problems regarding image quality (e.g., blurring, density, color tone, bleed-through) or image toughness (e.g., water resistance, fade resistance) will arise. These problems will not arise when a pretreatment liquid having a function of aggregating ink is previously applied to the recording medium before an image is formed thereon.

In the pretreatment part 302, the pretreatment liquid is uniformly applied to the surface of the recording medium 203 by any known application method. Specific examples of usable application method include, but are not limited to, blade coating, gravure coating, gravure offset coating, bar coating, roll coating, knife coating, air knife coating, comma coating, U comma coating, AKKU coating, smoothing coating, micro gravure coating, reverse roll coating, 4-roll or 5-roll coating, dip coating, curtain coating, slide coating, and die coating.

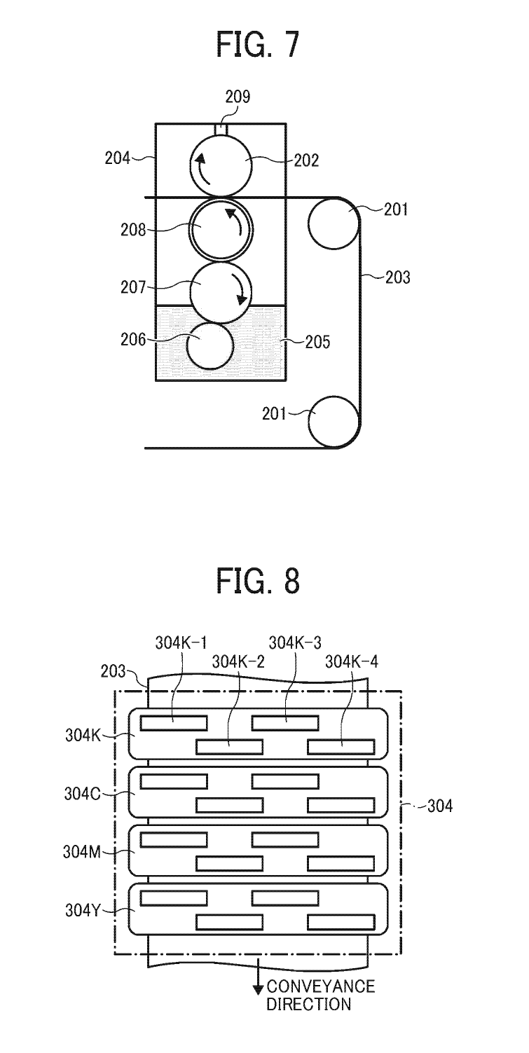

FIG. 7 is a schematic view of the pretreatment part 302. In the present embodiment, for an illustrative purpose, roll coating is employed as the pretreatment liquid application method.

Referring to FIG. 7, conveyance rollers 201 convey the recording medium 203, in the form of continuous paper, to a pretreatment liquid applicator 204. The pretreatment liquid applicator 204 retains a pretreatment liquid 205. The pretreatment liquid 205 is transferred onto a surface of an application roller 208 while being formed into a thin film, via a stirring supply roller 206 and a transfer-film-thinning roller 207.

The application roller 208 rotates while being pressed against a platen roller 202 that is rotating. The recording medium 203 passes through between the application roller 208 and the platen roller 202 so that the pretreatment liquid 205 is applied to the surface of the recording medium 203.

The nip pressure of the platen roller 202 at the time of applying the pretreatment liquid 205 to the recording medium 203 is adjustable by a pressure adjuster 209. The application amount of the pretreatment liquid 205 varies in accordance with variation in the nip pressure.

The application amount is also adjustable by varying the rotation speed of the application roller 208 and the platen roller 202. The application roller 208 and the platen roller 202 are driven by a power source (e.g., driving motor). The rotation speeds of the application roller 208 and the platen roller 202 vary in accordance with variation in the energy from the power source, to adjust the application amount.

Such a method of applying the pretreatment liquid 205 to a recording area on the recording medium 203 by the application roller 208 has an advantage over a method in which the pretreatment liquid 205 is sprayed to the recording medium 203 by an injection head. This is because this process makes it possible to form the pretreatment liquid 205, even having a relatively high viscosity, into a thin film on the recording medium 203 to suppress the occurrence of image blurring.

A post-pretreatment drying part 303 may be disposed on a downstream side from the pretreatment part 302, as illustrated in FIG. 7. The post-pretreatment drying part 303 includes heat rollers 311 and 312. The recording medium 203 to which the pretreatment liquid 205 has been applied is conveyed to the heat rollers 311 and 312 by conveyance rollers. The heat rollers 311 and 312 are heated to a high temperature in the range of from 50° C. to 100° C. Thus, upon contact of the heat rollers 311 and 312 with the recording medium 203 to which the pretreatment liquid 205 has been applied, moisture is evaporated from the recording medium 203 by transmission of heat, thus drying the recording medium 203. The configuration of the post-pretreatment drying part 303 is not limited to the above-described configuration. The post-pretreatment drying part 303 may include infrared dryer, microwave dryer, hot air device, or a combination thereof (e.g., a combination of heat roller and hot air device). It is also possible to preheat the recording medium 203 before the pretreatment liquid 205 is applied thereto.

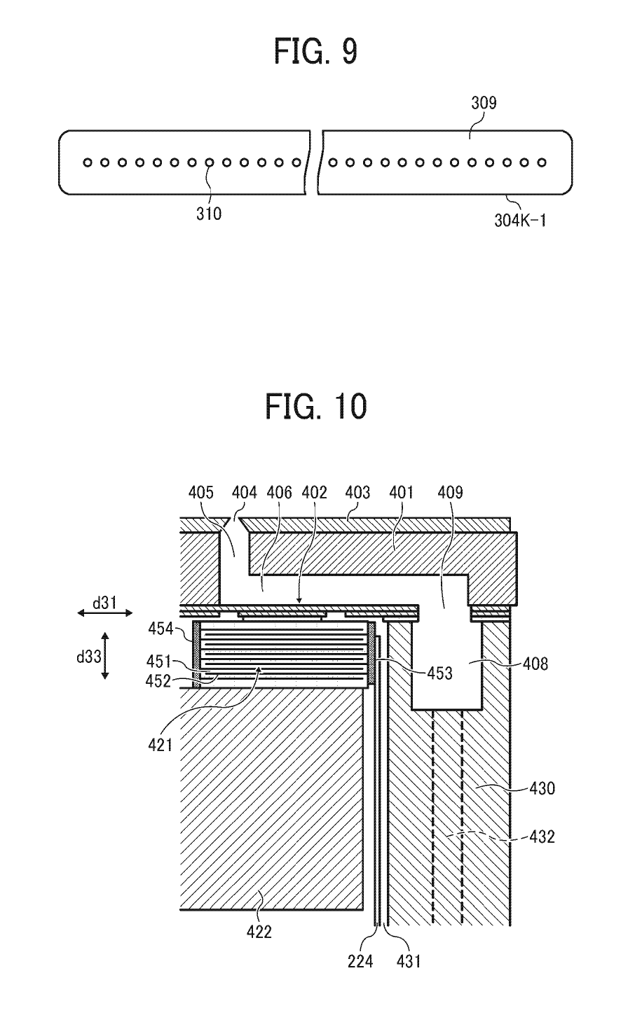

In the image forming part 304 disposed downstream from the pretreatment part 302, an image is formed on the recording medium 203 in accordance with image data. The image forming part 304 is a full-line head including four recording heads 304K, 304C, 304M, and 304Y, corresponding to respective inks of black, cyan, magenta, and yellow. The recording heads 304K, 304C, 304M, and 304Y are arranged in this order with 304K being the most upstream and 304Y being the most downstream relative to the direction of conveyance of the recording medium 203. Referring to FIG. 8, the recording head 304K includes four short head units 304K-1, 304K-2, 304K-3, and 304K-4 arranged in a zigzag manner in a direction perpendicular to the direction of conveyance of the recording medium 203. This configuration secures the width of printing area. FIG. 9 is a magnified view of the head unit 304K-1. The head unit 304K-1 has a nozzle surface 309 on which multiple printing nozzles 310 are arranged in line in the longitudinal direction of the head unit 304K-1 to form a nozzle array. In the present embodiment, only one nozzle array is provided for an illustrative purpose. The number of nozzle arrays is not limited to one. Each of the other recording heads 304C, 304M, and 304Y has the same configuration as the recording head 304K. The four recording heads 304K, 304C, 304M, and 304Y are arranged at regular intervals in the direction of conveyance of the recording medium 203. This configuration makes it possible to form an image over the entire printing area through one time of printing operation.

The colors of the inks are not limited to black, cyan, magenta, and yellow. For example, a light cyan photo ink may be used.

In the aftertreatment part 305 disposed downstream from the image forming part 304, an aftertreatment liquid is applied to the recording medium 203.

The aftertreatment liquid includes a component capable of forming a transparent protective layer on the recording medium 203.

In the aftertreatment part 305, the aftertreatment liquid is applied to the all part or a specific part of the surface of the image fonned on the recording medium 203. Preferably, the application amount and application method of the aftertreatment liquid are varied depending on printing conditions (e.g., the type of recording medium, the amount of ink discharged to the recording medium).

The method of applying the aftertreatment liquid is selected depending the type of the aftertreatment liquid. Preferably, the above-described method of applying the pretreatment liquid or method of discharging ink is used for the method of applying the aftertreatment liquid. In view of the apparatus configuration and storage stability of the aftertreatment liquid, the method of discharging ink is more preferably used therefor. This method makes it possible to apply a required amount of the aftertreatment liquid to any part of the image. The aftertreatment is a process in which the aftertreatment liquid including a transparent resin is applied to the surface of the image to form a protective layer in such a manner that the amount of deposit of the aftertreatment liquid when dried becomes in the range of from 0.5 to 10 g/m².

The amount of deposit of the aftertreatment liquid when dried is preferably in the range of from 0.5 to 10 g/m², and more preferably from m 2 to 8 g/². When the amount of deposit is less than 0.5 g/² m , image quality (e.g., image density, color saturation, gloss value, fixability) improves very little. When the amount of deposit is in excess of 10 g/m², drying property of the protective layer deteriorates and image-quality-enhancing effect becomes saturated, thus becoming more disadvantageous in terms of cost.

A post-aftertreatment drying part 306 may be disposed on a downstream side from aftertreatment part 305, as illustrated in FIG. 6.

The post-aftertreatment drying part 306 includes heat rollers 313 and 314. The recording medium 203 to which the aftertreatment liquid has been applied is conveyed to the heat rollers 313 and 314 by conveyance rollers. The heat rollers 313 and 314 are heated to a high temperature. Thus, upon contact of the heat rollers 313 and 314 with the recording medium 203 to which the aftertreatment liquid has been applied, moisture is evaporated from the recording medium 203 by transmission of heat, thus drying the recording medium 203. The configuration of the post-aftertreatment drying part 306 is not limited to the above-described configuration. The post-aftertreatment drying part 306 may include infrared dryer, microwave dryer, hot air device, or a combination thereof (e.g., a combination of heat roller and hot air device).

The dried recording medium 203 is winded up by the winder 308. When the pressing force of the winder 308 at the time of winding up the recording medium 203 is too large, there is a possibility that the image is transferred onto the back surface of the recording medium 203. To avoid such undesired transfer of the image, a pre-winding drying part 315 may be disposed, as illustrated in FIG. 6. The pre-winding drying part 315 may include infrared dryer, microwave dryer, hot air device, or a combination thereof (e.g., a combination of heat roller and hot air device).

### Head Structure

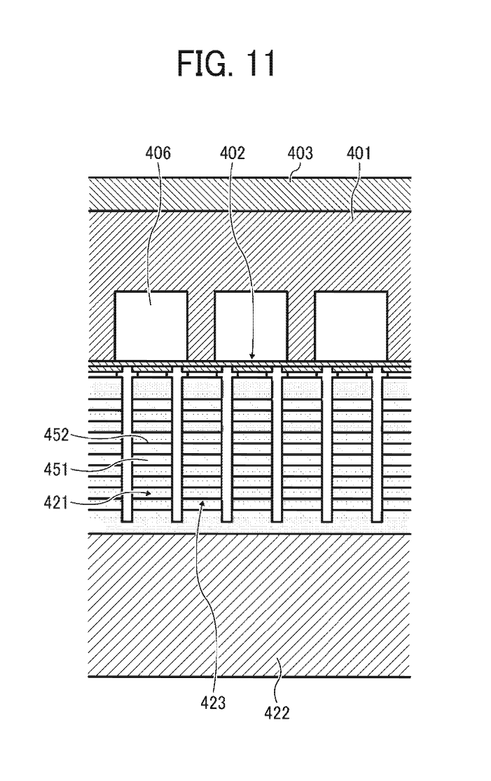

A droplet discharge head, serving as the recording head of the image forming apparatus according to an embodiment of the present invention is described below with reference of FIGS. 10 and 11. FIG. 10 is a cross-sectional schematic view of the droplet discharge head taken along the longitudinal direction of a liquid chamber of the head. FIG. 11 is a cross-sectional schematic view of the droplet discharge head taken along the short direction (i.e., the direction of arrangement of nozzles) of the liquid chamber of the head.

The droplet discharge head includes a channel substrate 401, a vibration plate 402, and a nozzle plate 403. The channel substrate 401 is formed by anisotropic etching of a monocrystal silicon substrate. The vibration plate 402, which may be formed of electroformed nickel, is joined to a lower surface of the channel substrate 401. The nozzle plate 403 is joined to an upper surface of the channel substrate 401. The channel substrate 401, vibration plate 402, and nozzle plate 403 are laminated to form a nozzle communication channel 405, a liquid chamber 406, and an ink supply port 409. The nozzle communication channel 405 is communicated with a nozzle 404 that discharges droplets of the ink. The ink supply port 409 is communicated with a common liquid chamber 408 for supplying the ink to the liquid chamber 406.

The droplet discharge head further includes a piezoelectric element 421 and a base substrate 422 to which the piezoelectric element 421 is fixedly joined. The piezoelectric element 421 is a two-row laminated actuator, serving as an electromechanical transducer, that deforms the vibration plate 402 to pressurize the ink in the liquid chamber 406. The piezoelectric element 421 includes a supporting part 423. The supporting part 423 is formed at the same the time when a piezoelectric element material is division-processed to form the piezoelectric element 421. The supporting part 423 merely functions as a support since no driving voltage is applied thereto.

The piezoelectric element 421 is connected to an FPC (flexible print circuit) cable 224 to be coupled to a driving circuit (driving IC).

The peripheral area of the vibration plate 402 is joined to a frame member 430. The frame member 430 has a penetrating part 431, a recess that is forming the common liquid chamber 408, and an ink supply though-hole 432. The penetrating part 431 stores an actuator unit including the piezoelectric element 421 and the base substrate 422 therein. The ink supply though-hole 432 supplies the ink to the common liquid chamber 408 from the outside. The frame member 430 may be formed by injection-molding of a thermosetting resin (e.g., epoxy resin) or polyphenylene sulfate.

The channel substrate 401 may be formed by anisotropic etching of a monocrystal silicon substrate having a crystal plane orientation of (110) with an alkaline etching liquid (e.g., aqueous solution of potassium hydroxide (KOH)), to have a recess and a through-hole serving as the nozzle communication channel 405 and the liquid chamber 406. The monocrystal silicon substrate can be replaced with a stainless-steel substrate or a photosensitive resin.

The vibration plate 402 may be formed of a nickel plate prepared by electroforming. The vibration plate 402 may also be formed of a metal plate or a metal-resin-bonded member.

To the vibration plate 402, the piezoelectric element 421 and the supporting part 423 are adhesively bonded. The frame member 430 is also adhesively bonded to the vibration plate 402.

The nozzle plate 403 has the nozzle 404 having a diameter in the range of from 10 to 30 μm corresponding to the liquid chamber 406. The nozzle plate 403 is adhesively bonded to the channel substrate 401. The nozzle plate 403 is formed of a metal member on which nozzles is formed, having a water repellent layer on its outermost surface.

The piezoelectric element 421 is a laminated piezoelectric element (e.g., piezoelectric zirconate titanate (PZT)) in which a piezoelectric material 451 and an internal electrode 452 are alternately laminated. The internal electrodes 452 are alternately drawn out from different edge faces of the piezoelectric element 421 and connected to an individual electrode 453 or a common electrode 454. In the present embodiment, the piezoelectric element 421 displaces in a d33 direction to pressurize the ink in the liquid chamber 406. Alternatively, the piezoelectric element 421 may displaces in a d31 direction to pressurize the ink in the liquid chamber 406. According to another embodiment, one row of the piezoelectric element 421 may be disposed on the base substrate 422.

In the droplet discharge head, as the voltage applied to the piezoelectric element 421 is decreased from the standard voltage, the piezoelectric element 421 contracts to lower the vibration plate 402 to expand the volume of the liquid chamber 406. Thus, the ink flows into the liquid chamber 406. As the voltage applied to the piezoelectric element 421 is increased, the piezoelectric element 421 expands in the direction of lamination to deform the vibration plate 402 toward the nozzle 404 to contract the volume of the liquid chamber 406. Thus, the ink in the liquid chamber 406 is pressurized and discharged (injected) from the nozzle 404 into droplets.

As the voltage applied to the piezoelectric element 421 is returned to the standard voltage, the vibration plate 402 returns to the initial position to expand the volume of the liquid chamber 406 while generating negative pressure. Thus, the liquid chamber 406 is filled with the ink from the common liquid chamber 408. After the vibration of the meniscus surface of the nozzle 404 has attenuated and stabilized, the operation transits to next discharge procedure.

The method of driving the head is not limited to the above-described procedure (i.e., drawing and pushing) and may be merely of drawing or pushing depending on drive waveform.

In the present embodiment, the pressure generator for pressurizing ink in an ink flow path may be of any of the following types: a piezo type in which a piezoelectric element deforms a vibration plate forming a wall surface of the ink flow path to vary the inner volume of the ink flow path to discharge droplets of the ink (as described in Japanese Examined Patent Application Publication No. 02-51734, corresponding to Japanese Unexamined Patent Application Publication No. 56-064877); a thermal type in which a heat element heats an ink in an ink flow path to generate bubbles (as described in Japanese Examined Patent Application Publication No. 61-59911, corresponding to Japanese Unexamined Patent Application Publication No. 54-059936); and an electrostatic type in which a vibration plate forming a wall surface of an ink flow path and an electrode are facing each other and an electrostatic force generated between the vibration plate and the electrode deforms the vibration plate to vary the inner volume of the ink flow path to discharge droplets of the ink (as described in Japanese Unexamined Patent Application Publication No. 06-71882).

### Ink Recorded Matter

Ink recorded matter according to an embodiment of the present invention is recorded by the above-described inkjet recording apparatus and inkjet recording method.

The ink recorded matter includes a recording medium and an image formed with the ink on the recording medium.

Specific examples of the recording medium include, but are not limited to, plain paper, glossy paper, special paper, clothes, film, overhead projector (OHP) transparency, and general-purpose printing paper. Each of these recording media can be used alone or in combination with others.

The ink recorded matter has high image quality without blurring and excellent temporal stability. The ink recorded matter can be used for various purposes such as a material for recording texts and/or images.

### EXAMPLES

Having generally described this invention, further understanding can be obtained by reference to certain specific examples which are provided herein for the purpose of illustration only and are not intended to be limiting. In the descriptions in the following examples, the numbers represent mass ratios in parts, unless otherwise specified.

### Preparation of Polymers

### Production Example 1

### Synthesis of Vinyl Polymer A1

After sufficiently replacing the air in a 1-L flask equipped with a mechanical stirrer, a thermometer, a nitrogen gas inlet pipe, a reflux pipe, and a dropping funnel with nitrogen gas, 11.2 g of styrene, 2.8 g of acrylic acid, 12.0 g of lauryl methacrylate, 4.0 g of polyethylene glycol methacrylate, 4.0 g of a styrene macromer (AS-6 available from Toagosei Co., Ltd.), and 0.4 g of mercaptoethanol were contained in the flask, and the temperature was raised to 65° C. Next, a mixture liquid containing 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of a styrene macromer (AS-6 available from Toagosei Co., Ltd.), 3.6 g of mercaptoethanol, 2.4 g of azobis dimethylvaleronitrile, and 18 g of methyl ethyl ketone was dropped in the flask over a period of 2.5 hours.

Thereafter, another mixture liquid containing 0.8 g of azobis dimethylvaleronitrile and 18 g of methyl ethyl ketone was further dropped in the flask over a period of 0.5 hours. After aging the mixture at 65° C. for 1 hour, 0.8 g of azobis dimethylvaleronitrile was added thereto, and the mixture was further aged for 1 hour. Thus, a vinyl polymer A1 was prepared. The vinyl polymer A1 had a weight average molecular weight of 15,000 when measured by the above-described method.

### Production Example 2

### Synthesis of Vinyl Polymer A2

After sufficiently replacing the air in a 1-L flask equipped with a mechanical stirrer, a thermometer, a nitrogen gas inlet pipe, a reflux pipe, and a dropping funnel with nitrogen gas, 11.2 g of styrene, 2.8 g of acrylic acid, 12.0 g of lauryl methacrylate, 4.0 g of polyethylene glycol methacrylate, 4.0 g of a styrene macromer (AS-6 available from Toagosei Co., Ltd.), and 0.55 g of mercaptoethanol were contained in the flask, and the temperature was raised to 65° C. Next, a mixture liquid containing 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of a styrene macromer (AS-6 available from Toagosei Co., Ltd.), 4.95 g of mercaptoethanol, 2.4 g of azobis dimethylvaleronitrile, and 18 g of methyl ethyl ketone was dropped in the flask over a period of 2.5 hours.

Thereafter, another mixture liquid containing 0.8 g of azobis dimethylvaleronitrile and 18 g of methyl ethyl ketone was further dropped in the flask over a period of 0.5 hours. After aging the mixture at 65° C. for 1 hour, 0.8 g of azobis dimethylvaleronitrile was added thereto, and the mixture was further aged for 1 hour. Thus, a vinyl polymer A2 was prepared. The vinyl polymer A2 had a weight average molecular weight of 11,000 when measured by the above-described method.

### Production Example 3

### Synthesis of Polyester Polymer A3

A 10-L four-necked flask equipped with a thermometer, a stirrer, a flow down type condenser, and a nitrogen inlet pipe was charged with 3,500 g of polyoxypropylene (2.2) adduct of bisphenol A, 1,625 g of polyoxyethylene (2.0) adduct of bisphenol A, 1,180 g of hydrogenated bisphenol A, 3,088 g of isophthalic acid, and 20 g of dibutyl tin oxide. The temperature was raised to 180° C. and then to 230° C. over a period of 5 hours in a mantle heater under nitrogen atmosphere. The flask contents were subjected to a reaction at 230° C. for 5 hours. The temperature was then lowered to 180° C., and 116 g of fumaric acid was added to the flask. The temperature was raised to 200° C. over a period of 3 hours, and then the flask contents were subjected to a reaction at 200° C. and 8 kPa. Thus, a polyester polymer A3 was prepared. The polyester polymer A3 had a weight average molecular weight of 18,000 when measured by the above-described method.

### Production Example 4

### Synthesis of Polyester Polymer A4

A 10-L four-necked flask equipped with a thermometer, a stirrer, a flow down type condenser, and a nitrogen inlet pipe was charged with 3,500 g of polyoxypropylene (2.2) adduct of bisphenol A, 1,625 g of polyoxyethylene (2.0) adduct of bisphenol A, 1,180 g of hydrogenated bisphenol A, 2,722 g of isophthalic acid, and 20 g of dibutyl tin oxide. The flask contents were heated to 180° C. and then to 230° C. over a period of 5 hours in a mantle heater under nitrogen atmosphere. The flask contents were subjected to a reaction at 230° C. for 5 hours. The temperature was then lowered to 180° C., and 464 g of fumaric acid was added to the flask. The temperature was raised to 200° C. over a period of 3 hours, and then the flask contents were subjected to a reaction at 200° C. and 8 kPa. Thus, a polyester polymer A4 was prepared. The polyester polymer A4 had a weight average molecular weight of 18,000 when measured by the above-described method.

### Production Example 5

### Synthesis of Polyurethane Polymer A5

In a reaction vessel, 170 g of acetone (special grade, available from Wako Pure Chemical Industries, Ltd.) which had been previously dehydrated with Molecular Sieves 3A (available from Wako Pure Chemical Industries, Ltd.), 120 g of tetramethylxylylene diisocyanate (TMXDI available from Nihon Cytec Industries Inc.), 32 g of bishydroxymethyl butyric acid (available from Tokyo Chemical Industry Co., Ltd.), 50 g of an EO (4 mol) adduct of hydrogenated bisphenol A (HBPA-E04 available from Maruzen Petrochemical Co., Ltd.), and 50 g of triethylene glycol (available from Wako Pure Chemical Industries, Ltd.) were mixed. After sufficiently replacing the air in the vessel with nitrogen gas, the temperature was raised to 70° C. and kept at 70° C. for one hour. The temperature was then raised to 75° C. Thereafter, the temperature was raised 5 degrees every one hour. After raising the temperature to 90° C. and kept at 90° C. for one hour, the vessel contents were cooled to normal temperature. Thus, a polyurethane polymer A5 was prepared. The polyurethane polymer A5 had a weight average molecular weight of 17,000 when measured by the above-described method.

### Production Example 6

### Synthesis of Polyurethane Polymer A6

In a reaction vessel, 170 g of acetone (special grade, available from Wako Pure Chemical Industries, Ltd.) which had been previously dehydrated with Molecular Sieves 3A (available from Wako Pure Chemical Industries, Ltd.), 110 g of tetramethylxylylene diisocyanate (TMXDI available ftom Nihon Cytec Industries Inc.), 32 g of bishydroxymethyl butyric acid (available from Tokyo Chemical Industry Co., Ltd.), 50 g of an EO (4 mol) adduct of hydrogenated bisphenol A (HBPA-E04 available from Maruzen Petrochemical Co., Ltd.), and 50 g of triethylene glycol (available from Wako Pure Chemical Industries, Ltd.) were mixed. After sufficiently replacing the air in the vessel with nitrogen gas, the temperature was raised to 70° C. and kept at 70° C. for one hour. The temperature was then raised to 75° C. Thereafter, the temperature was raised 5 degrees every one hour. After raising the temperature to 90° C. and kept at 90° C. for one hour, the vessel contents were cooled to normal temperature. Thus, a polyurethane polymer A6 was prepared. The polyurethane polymer A6 had a weight average molecular weight of 12,000 when measured by the above-described method.

### Preparation of Resin-Coated Pigment Dispersion Liquids

### Production Example 7

### Preparation of Resin-Coated Pigment Dispersion Liquid 1 to 36

A beaker was charged with 50 g of the above-prepared polymer A 1, A2, A3, A4, A5, or A6 and a solvent according to the formula described in Table 1, to prepare polymer solutions having a concentration of 50% by mass.

Each polymer solution in an amount described in Table 1, 42 g of each pigment, 20 g of each solvent, 13.6 g of a 1-mol/L aqueous solution of potassium hydroxide, and 13.6 g of ion-exchange water were sufficiently mixed and stirred. The resulting mixture was kneaded with a roll mill. The resulting paste was poured in 200 g of pure water and sufficiently stirred, and the solvent and water were evaporated therefrom using an evaporator. The resulting dispersion liquid was subjected to pressure filtration using a polyvinylidene fluoride membrane filter having an average pore diameter of 5.0 μm to remove coarse particles. Thus, resin-coated pigment dispersion liquids 1 to 36 having a pigment content of 15% by mass were prepared.

TABLE 1

| | | | | | Polymer |
|---|---|---|---|---|---|
| | | | | | Solution |
| | | | | | Addition |
| | | | | | Amount |
| | Solvent | Pigment | Polymer | | (g) |
| Resin-Coated Pigment Dispersion Liquid 1 | MEK | Carbon Black (*1) | Vinyl Polymer | A1 | 16.8 |
| Resin-Coated Pigment Dispersion Liquid 2 | MEK | C.I. Pigment Blue 15 | Vinyl Polymer | A1 | 49.0 |
| Resin-Coated Pigment Dispersion Liquid 3 | MEK | C.I. Pigment Red 122 | Polyester Polymer | A3 | 88.2 |
| Resin-Coated Pigment Dispersion Liquid 4 | Acetone | C.I. Pigment Yellow 74 | Polyurethane Polymer | A5 | 30.8 |
| Resin-Coated Pigment Dispersion Liquid 5 | MEK | Carbon Black (*1) | Vinyl Polymer | A2 | 44.1 |
| Resin-Coated Pigment Dispersion Liquid 6 | MEK | C.I. Pigment Blue 15 | Polyester Polymer | A4 | 92.4 |
| Resin-Coated Pigment Dispersion Liquid 7 | Acetone | C.I. Pigment Red 122 | Polyurethane Polymer | A6 | 45.5 |
| Resin-Coated Pigment Dispersion Liquid 8 | MEK | C.I. Pigment Yellow 74 | Vinyl Polymer | A1 | 42.0 |
| Resin-Coated Pigment Dispersion Liquid 9 | MEK | Carbon Black (*1) | Vinyl Polymer | A2 | 69.3 |
| Resin-Coated Pigment Dispersion Liquid 10 | MEK | C.I. Pigment Blue 15 | Vinyl Polymer | A2 | 45.5 |
| Resin-Coated Pigment Dispersion Liquid 11 | MEK | C.I. Pigment Red 122 | Vinyl Polymer | A1 | 58.8 |
| Resin-Coated Pigment Dispersion Liquid 12 | MEK | C.I. Pigment Yellow 74 | Polyester Polymer | A3 | 28.0 |
| Resin-Coated Pigment Dispersion Liquid 13 | Acetone | Carbon Black (*1) | Polyurethane Polymer | A5 | 38.5 |
| Resin-Coated Pigment Dispersion Liquid 14 | MEK | C.I. Pigment Blue 15 | Vinyl Polymer | A2 | 45.5 |
| Resin-Coated Pigment Dispersion Liquid 15 | MEK | C.I. Pigment Red 122 | Vinyl Polymer | A1 | 84.0 |
| Resin-Coated Pigment Dispersion Liquid 16 | MEK | C.I. Pigment Yellow 74 | Vinyl Polymer | A1 | 42.0 |
| Resin-Coated Pigment Dispersion Liquid 17 | Acetone | Carbon Black (*1) | Polyurethane Polymer | A6 | 84.0 |
| Resin-Coated Pigment Dispersion Liquid 18 | Acetone | C.I. Pigment Blue 15 | Polyurethane Polymer | A5 | 49.0 |
| Resin-Coated Pigment Dispersion Liquid 19 | Acetone | C.I. Pigment Red 122 | Polyurethane Polymer | A5 | 54.6 |
| Resin-Coated Pigment Dispersion Liquid 20 | Acetone | C.I. Pigment Yellow 74 | Polyurethane Polymer | A6 | 69.3 |
| Resin-Coated Pigment Dispersion Liquid 21 | Acetone | Carbon Black (*1) | Polyurethane Polymer | A6 | 16.8 |
| Resin-Coated Pigment Dispersion Liquid 22 | Acetone | C.I. Pigment Blue 15 | Polyurethane Polymer | A5 | 58.8 |
| Resin-Coated Pigment Dispersion Liquid 23 | Acetone | C.I. Pigment Red 122 | Polyurethane Polymer | A6 | 33.6 |
| Resin-Coated Pigment Dispersion Liquid 24 | Acetone | C.I. Pigment Yellow 74 | Polyurethane Polymer | A6 | 84.0 |
| Resin-Coated Pigment Dispersion Liquid 25 | MEK | Carbon Black (*1) | Vinyl Polymer | A1 | 50.4 |
| Resin-Coated Pigment Dispersion Liquid 26 | MEK | C.I. Pigment Blue 15 | Polyester Polymer | A3 | 42.1 |
| Resin-Coated Pigment Dispersion Liquid 27 | Acetone | C.I. Pigment Red 122 | Polyurethane Polymer | A6 | 8.4 |
| Resin-Coated Pigment Dispersion Liquid 28 | MEK | C.I. Pigment Yellow 74 | Vinyl Polymer | A2 | 91.0 |
| Resin-Coated Pigment Dispersion Liquid 29 | MEK | Carbon Black (*1) | Vinyl Polymer | A1 | 63.7 |
| Resin-Coated Pigment Dispersion Liquid 30 | MEK | C.I. Pigment Blue 15 | Vinyl Polymer | A2 | 42.0 |
| Resin-Coated Pigment Dispersion Liquid 31 | MEK | C.I. Pigment Red 122 | Polyester Polymer | A4 | 42.0 |
| Resin-Coated Pigment Dispersion Liquid 32 | MEK | C.I. Pigment Yellow 74 | Vinyl Polymer | A1 | 61.6 |
| Resin-Coated Pigment Dispersion Liquid 33 | Acetone | Carbon Black (*1) | Polyurethane Polymer | A5 | 42.0 |
| Resin-Coated Pigment Dispersion Liquid 34 | MEK | C.I. Pigment Blue 15 | Vinyl Polymer | A1 | 42.0 |
| Resin-Coated Pigment Dispersion Liquid 35 | Acetone | C.I. Pigment Red 122 | Polyurethane Polymer | A5 | 42.0 |
| Resin-Coated Pigment Dispersion Liquid 36 | Acetone | C.I. Pigment Yellow 74 | Polyurethane Polymer | A6 | 42.0 |

MEK: Methyl Ethyl Ketone,
(*1) Carbon Black: FW100 available from Degussa

### Preparation of Resin Emulsions

### Production Example 8

### Preparation of Resin Emulsions B1 to B4

According to Table 2, 200 g of each vinyl polymer and 10 g of an anionic surfactant (NEOPELEX G-15 available from Kao Corporation) in a solid state were mixed and dissolved in 200 g of methyl ethyl ketone at 25° C. Next, 600 g of ion-exchange water and 3.0 g of 25% ammonia water were mixed in a 2,000-mL stainless steel beaker made of SUS304. The above-prepared solution was added thereto and subjected to a dispersion treatment using an ultrasonic homogenizer (UP-400S available from Hielscher) at 30° C. and 400 W for an operation time described in Table 2. The temperature was then raised to 50° C., and methyl ethyl ketone was removed from the resulting dispersion under reduced pressures. An amount of ion-exchange water was added to the dispersion to adjust the solid content to 30% by mass. Thus, resin emulsions B1 to B4 containing the vinyl polymer A 1 or A2 were prepared. The volume average particle diameter of each resin emulsion is described in Table 2.

TABLE 2

| | | |
|---|---|---|
| | | Volume |
| | | Average |
| | | Particle |
| | Homogenizer | Diameter |
| Polymer | Operation Time | (nm) |

| | | | | | |
|---|---|---|---|---|---|
| Resin | Vinyl | A1 | 1 | h | 8 |
| Emulsion B1 | Polymer | | | | |
| Resin | Vinyl | A1 | 45 | min | 10 |
| Emulsion B2 | Polymer | | | | |
| Resin | Vinyl | A2 | 30 | min | 15 |
| Emulsion B3 | Polymer | | | | |
| Resin | Vinyl | A2 | 10 | min | 22 |
| Emulsion B4 | Polymer | | | | |

### Production Example 9

### Preparation of Resin Emulsions B5 to B7

According to Table 3, 200 g of each polyester polymer and 10 g of an anionic surfactant (NEOPELEX G-15 available from Kao Corporation) in a solid state were mixed and dissolved in 200 g of methyl ethyl ketone at 25° C. Next, 600 g of ion-exchange water and 3.0 g of 25% ammonia water were mixed in a 2,000-mL stainless steel beaker made of SUS304. The above-prepared solution was added thereto and subjected to a dispersion treatment using an ultrasonic homogenizer (UP-400S available from Hielscher) at 30° C. and 400 W for an operation time described in Table 3. The temperature was then raised to 50° C., and methyl ethyl ketone was removed from the resulting dispersion under reduced pressures.

An amount of ion-exchange water was added to the dispersion to adjust the solid content to 30% by mass. Thus, resin emulsions B5 to B7 containing the polyester polymer A3 or A4 were prepared. The volume average particle diameter of each resin emulsion is described in Table 3.

TABLE 3

| | | |
|---|---|---|
| | | Volume |
| | | Average |
| | | Particle |
| | Homogenizer | Diameter |
| Polymer | Operation Time | (nm) |

| | | | | | |
|---|---|---|---|---|---|
| Resin | Polyester | A3 | 5 | h | 5 |
| Emulsion B5 | Polymer | | | | |
| Resin | Polyester | A3 | 30 | min | 15 |
| Emulsion B6 | Polymer | | | | |
| Resin | Polyester | A4 | 18 | min | 19 |
| Emulsion B7 | Polymer | | | | |

### Production Example 10

### Preparation of Resin Emulsions B8 to B13

According to Table 4, each polyurethane polymer was diluted with an appropriate amount of acetone to adjust the solid content to 40%. Thus, acetone solutions of polyurethane were prepared. Next, 150 g of each acetone solution of polyurethane, 10 g of an anionic surfactant (NEOPELEX G-15 available from Kao Corporation) in a solid state, 8 g of triethylamine (special grade, available from Wako Pure Chemical Industries, Ltd.), and 600 g of ion-exchange water were mixed in a 2,000-mL stainless steel beaker made of SUS304, and subjected to a dispersion treatment using an ultrasonic homogenizer (UP-400S available from Hielscher) at 30° C. and 400 W for an operation time described in Table 4. The temperature was then raised to 50° C., and acetone was removed from the resulting dispersion under reduced pressures using an evaporator. An amount of ion-exchange water was added to the dispersion to adjust the solid content to 30% by mass. Thus, resin emulsions B8 to B13 containing the polyurethane polymer A5 or A6 were prepared. The volume average particle diameter of each resin emulsion is described in Table 4.

TABLE 4

| | | | | | Volume |
|---|---|---|---|---|---|
| | | | | | Average |
| | | | | | Particle |
| | | | Homogenizer | | Diameter |
| | Polymer | | Operation Time | | (nm) |
| Resin | Polyurethane | A5 | 2 | h | 7 |
| Emulsion B8 | Polymer | | | | |
| Resin | Polyurethane | A5 | 1 | h | 8 |
| Emulsion B9 | Polymer | | | | |
| Resin | Polyurethane | A5 | 45 | min | 10 |
| Emulsion B10 | Polymer | | | | |
| Resin | Polyurethane | A6 | 30 | min | 15 |
| Emulsion B11 | Polymer | | | | |
| Resin | Polyurethane | A6 | 18 | min | 19 |
| Emulsion B12 | Polymer | | | | |
| Resin | Polyurethane | A5 | 15 | min | 20 |
| Emulsion B13 | Polymer | | | | |

### Preparation of Inks

According to the formulations described in Tables 5-1 to 5-3, a water-soluble organic solvent, a penetrant, a surfactant, an antifungal agent, an aliphatic diol, and water were uniformly stirred and mixed for one hour. According to the formulations described in Tables 5-1 to 5-3, a resin emulsion was added to the mixture liquid and stirred for one hour, and then a resin-coated pigment dispersion liquid and a defoamer were further added to the mixture liquid and stirred for one hour. The resulting dispersion liquid was subjected to pressure filtration using a polyvinylidene fluoride membrane filter having an average pore diameter of 0.8 μm to remove coarse particles and foreign substances. Thus, inks of Examples 1 to 24 and Comparative Examples 1 to 12 were prepared.

TABLE 5-1

| | | | Examples | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| | | | K | C | M | Y | K | C | M | Y | K | C | M | Y |
| Resin-Coated | Resin-Coated Pigment Dispersion Liquid 1 | | 40.0 | | | | | | | | | | | |
| Pigment | Resin-Coated Pigment Dispersion Liquid 2 | | | 40.0 | | | | | | | | | | |
| Dispersion | Resin-Coated Pigment Dispersion Liquid 3 | | | | 40.0 | | | | | | | | | |
| Liquid | Resin-Coated Pigment Dispersion Liquid 4 | | | | | 40.0 | | | | | | | | |
| | Resin-Coated Pigment Dispersion Liquid 5 | | | | | | 40.0 | | | | | | | |
| | Resin-Coated Pigment Dispersion Liquid 6 | | | | | | | 40.0 | | | | | | |
| | Resin-Coated Pigment Dispersion Liquid 7 | | | | | | | | 40.0 | | | | | |
| | Resin-Coated Pigment Dispersion Liquid 8 | | | | | | | | | 40.0 | | | | |
| | Resin-Coated Pigment Dispersion Liquid 9 | | | | | | | | | | 40.0 | | | |
| | Resin-Coated Pigment Dispersion Liquid 10 | | | | | | | | | | | 40.0 | | |
| | Resin-Coated Pigment Dispersion Liquid 11 | | | | | | | | | | | | 40.0 | |
| | Resin-Coated Pigment Dispersion Liquid 12 | | | | | | | | | | | | | 40.0 |
| | Resin-Coated Pigment Dispersion Liquid 13 | | | | | | | | | | | | | |
| | Resin-Coated Pigment Dispersion Liquid 14 | | | | | | | | | | | | | |
| | Resin-Coated Pigment Dispersion Liquid 15 | | | | | | | | | | | | | |
| | Resin-Coated Pigment Dispersion Liquid 16 | | | | | | | | | | | | | |
| | Resin-Coated Pigment Dispersion Liquid 17 | | | | | | | | | | | | | |
| | Resin-Coated Pigment Dispersion Liquid 18 | | | | | | | | | | | | | |
| | Resin-Coated Pigment Dispersion Liquid 19 | | | | | | | | | | | | | |
| | Resin-Coated Pigment Dispersion Liquid 20 | | | | | | | | | | | | | |
| | Resin-Coated Pigment Dispersion Liquid 21 | | | | | | | | | | | | | |
| | Resin-Coated Pigment Dispersion Liquid 22 | | | | | | | | | | | | | |
| | Resin-Coated Pigment Dispersion Liquid 23 | | | | | | | | | | | | | |
| | Resin-Coated Pigment Dispersion Liquid 24 | | | | | | | | | | | | | |
| | Resin-Coated Pigment Dispersion Liquid 25 | | | | | | | | | | | | | |
| | Resin-Coated Pigment Dispersion Liquid 26 | | | | | | | | | | | | | |
| | Resin-Coated Pigment Dispersion Liquid 27 | | | | | | | | | | | | | |
| | Resin-Coated Pigment Dispersion Liquid 28 | | | | | | | | | | | | | |
| | Resin-Coated Pigment Dispersion Liquid 29 | | | | | | | | | | | | | |
| | Resin-Coated Pigment Dispersion Liquid 30 | | | | | | | | | | | | | |
| | Resin-Coated Pigment Dispersion Liquid 31 | | | | | | | | | | | | | |
| | Resin-Coated Pigment Dispersion Liquid 32 | | | | | | | | | | | | | |
| | Resin-Coated Pigment Dispersion Liquid 33 | | | | | | | | | | | | | |
| | Resin-Coated Pigment Dispersion Liquid 34 | | | | | | | | | | | | | |
| | Resin-Coated Pigment Dispersion Liquid 35 | | | | | | | | | | | | | |
| | Resin-Coated Pigment Dispersion Liquid 36 | | | | | | | | | | | | | |
| Resin | Resin Emulsion B1 | | | | | | | | | 10.0 | | | | |
| Emulsion | Resin Emulsion B2 | | 2.7 | | | | 12.8 | | | | | 5.8 | | |
| | Resin Emulsion B3 | | | 11.7 | | | | | | | 13.5 | | 9.3 | |
| | Resin Emulsion B4 | | | | | | | | | | | | | |
| | Resin Emulsion B5 | | | | | | | | | | | | | |
| | Resin Emulsion B6 | | | | | | | 14.7 | | | | | | 6.7 |
| | Resin Emulsion B7 | | | | 9.0 | | | | | | | | | |
| | Resin Emulsion B8 | | | | | | | | | | | | | |
| | Resin Emulsion B9 | | | | | | | | | | | | | |
| | Resin Emulsion B10 | | | | | 6.0 | | | 5.8 | | | | | |
| | Resin Emulsion B11 | | | | | | | | | | | | | |
| | Resin Emulsion B12 | | | | | | | | | | | | | |
| | Resin Emulsion B13 | | | | | | | | | | | | | |
| Water-soluble | X | 2,3-Butanediol (b.p. 182) | | 30.0 | | | 25.0 | | 35.0 | | | | | 30.0 |
| Organic | | Propylene Glycol (b.p. 388) | 25.0 | | 35.0 | 30.0 | | 30.0 | | 30.0 | 25.0 | 30.0 | 35.0 | |
| Solvent | | 1,2,6-Hexanetriol (b.p. 178) | | | | | | | | | | | | |
| | Y | 1,2-Butanediol (b.p. 193) | 10.0 | | | | 10.0 | 7.0 | | 7.0 | | 7.0 | | 7.0 |
| | | Diethylene Glycol Monomethyl Ether | | 7.0 | | 7.0 | | | | | 10.0 | | | |
| | | (b.p. 194) | | | | | | | | | | | | |
| | | Ethylene Glycol Mono-2-Ethylhexyl | | | | | | | | | | | | |
| | | Ether (b.p. 229) | | | | | | | | | | | | |
| | G | Glycerin (b.p. 290) | 4.0 | | 4.0 | 4.0 | | 4.0 | 4.0 | | 4.0 | 4.0 | 4.0 | |
| | | Triethylene Glycol (b.p. 285) | | 4.0 | | | 4.0 | | | 4.0 | | | | |
| | | Diethylene Glycol (b.p. 245) | | | | | | | | | | | | 4.0 |
| Penetrant | | 2-Ethyl-1,3-hexanediol | 1.0 | 1.0 | 1.0 | 1.0 | | | | | 1.0 | 1.0 | 1.0 | 1.0 |
| | | 2,2,4-Trimethyl-1,3-pentanediol | | | | | 1.0 | 1.0 | 1.0 | 1.0 | | | | |
| Surfactant | | Zonyl ® FS-300 | | | | | 2.5 | 2.5 | 2.5 | 2.5 | | | | |
| | | SOFTANOL EP-7025 | | | | | | | | | 1.0 | 1.0 | 1.0 | 1.0 |
| | | UNIDYNE DSN-403N | 0.5 | 0.5 | 0.5 | 0.5 | | | | | | | | |
| Antifungal | | Proxel GXL | 0.05 | 0.05 | 0.05 | 0.05 | 0.05 | 0.05 | 0.05 | 0.05 | 0.05 | 0.05 | 0.05 | 0.05 |
| agent | | | | | | | | | | | | | | |
| Defoamer | | Silicone Defoamer KM-72F | 0.1 | 0.1 | 0.1 | 0.1 | 0.1 | 0.1 | 0.1 | 0.1 | 0.1 | 0.1 | 0.1 | 0.1 |
| Aliphatic Diol | | SURFYNOL AD01 | 0.30 | 0.50 | 0.10 | 0.70 | 0.10 | 0.50 | 0.05 | 0.25 | 0.26 | 0.04 | 0.80 | 0.50 |

| | | | | | | | | | | | | |
|---|---|---|---|---|---|---|---|---|---|---|---|---|
| Pure Water | Residual | Residual | Residual | Residual | Residual | Residual | Residual | Residual | Residual | Residual | Residual | Residual |
| | quantity | quantity | quantity | quantity | quantity | quantity | quantity | quantity | quantity | quantity | quantity | quantity |
| Total | 100.0 | 100.0 | 100.0 | 100.0 | 100.0 | 100.0 | 100.0 | 100.0 | 100.0 | 100.0 | 100.0 | 100.0 |

TABLE 5-2

| | | | 13 | 14 | 15 | 16 | 17 | 18 | 19 | 20 | 21 | 22 | 23 | 24 |
|---|---|---|---|---|---|---|---|---|---|---|---|---|---|---|
| | | | K | C | M | Y | K | C | M | Y | K | C | M | Y |
| Resin-Coated | Resin-Coated Pigment Dispersion Liquid 1 | | | | | | | | | | | | | |
| Pigment | Resin-Coated Pigment Dispersion Liquid 2 | | | | | | | | | | | | | |
| Dispersion | Resin-Coated Pigment Dispersion Liquid 3 | | | | | | | | | | | | | |
| Liquid | Resin-Coated Pigment Dispersion Liquid 4 | | | | | | | | | | | | | |
| | Resin-Coated Pigment Dispersion Liquid 5 | | | | | | | | | | | | | |
| | Resin-Coated Pigment Dispersion Liquid 6 | | | | | | | | | | | | | |
| | Resin-Coated Pigment Dispersion Liquid 7 | | | | | | | | | | | | | |
| | Resin-Coated Pigment Dispersion Liquid 8 | | | | | | | | | | | | | |
| | Resin-Coated Pigment Dispersion Liquid 9 | | | | | | | | | | | | | |
| | Resin-Coated Pigment Dispersion Liquid 10 | | | | | | | | | | | | | |
| | Resin-Coated Pigment Dispersion Liquid 11 | | | | | | | | | | | | | |
| | Resin-Coated Pigment Dispersion Liquid 12 | | | | | | | | | | | | | |
| | Resin-Coated Pigment Dispersion Liquid 13 | | 40.0 | | | | | | | | | | | |
| | Resin-Coated Pigment Dispersion Liquid 14 | | | 40.0 | | | | | | | | | | |
| | Resin-Coated Pigment Dispersion Liquid 15 | | | | 40.0 | | | | | | | | | |
| | Resin-Coated Pigment Dispersion Liquid 16 | | | | | 40.0 | | | | | | | | |
| | Resin-Coated Pigment Dispersion Liquid 17 | | | | | | 40.0 | | | | | | | |
| | Resin-Coated Pigment Dispersion Liquid 18 | | | | | | | 40.0 | | | | | | |
| | Resin-Coated Pigment Dispersion Liquid 19 | | | | | | | | 40.0 | | | | | |
| | Resin-Coated Pigment Dispersion Liquid 20 | | | | | | | | | 40.0 | | | | |
| | Resin-Coated Pigment Dispersion Liquid 21 | | | | | | | | | | 40.0 | | | |
| | Resin-Coated Pigment Dispersion Liquid 22 | | | | | | | | | | | 40.0 | | |
| | Resin-Coated Pigment Dispersion Liquid 23 | | | | | | | | | | | | 40.0 | |
| | Resin-Coated Pigment Dispersion Liquid 24 | | | | | | | | | | | | | 40.0 |
| | Resin-Coated Pigment Dispersion Liquid 25 | | | | | | | | | | | | | |
| | Resin-Coated Pigment Dispersion Liquid 26 | | | | | | | | | | | | | |
| | Resin-Coated Pigment Dispersion Liquid 27 | | | | | | | | | | | | | |
| | Resin-Coated Pigment Dispersion Liquid 28 | | | | | | | | | | | | | |
| | Resin-Coated Pigment Dispersion Liquid 29 | | | | | | | | | | | | | |
| | Resin-Coated Pigment Dispersion Liquid 30 | | | | | | | | | | | | | |
| | Resin-Coated Pigment Dispersion Liquid 31 | | | | | | | | | | | | | |
| | Resin-Coated Pigment Dispersion Liquid 32 | | | | | | | | | | | | | |
| | Resin-Coated Pigment Dispersion Liquid 33 | | | | | | | | | | | | | |
| | Resin-Coated Pigment Dispersion Liquid 34 | | | | | | | | | | | | | |
| | Resin-Coated Pigment Dispersion Liquid 35 | | | | | | | | | | | | | |
| | Resin-Coated Pigment Dispersion Liquid 36 | | | | | | | | | | | | | |
| Resin | Resin Emulsion B1 | | | | | 6.7 | | | | | | | | |
| Emulsion | Resin Emulsion B2 | | | 5.8 | | | | | | | | | | |
| | Resin Emulsion B3 | | | | 13.3 | | | | | | | | | |
| | Resin Emulsion B4 | | | | | | | | | | | | | |
| | Resin Emulsion B5 | | | | | | | | | | | | | |
| | Resin Emulsion B6 | | | | | | | | | | | | | |
| | Resin Emulsion B7 | | | | | | | | | | | | | |
| | Resin Emulsion B8 | | | | | | | | | | | | | |
| | Resin Emulsion B9 | | | | | | | | 7.0 | | | | | |
| | Resin Emulsion B10 | | | | | | 13.3 | | | | 2.7 | | 5.3 | 13.3 |
| | Resin Emulsion B11 | | 7.5 | | | | | | | 20.2 | | 9.3 | | |
| | Resin Emulsion B12 | | | | | | | 5.0 | | | | | | |
| | Resin Emulsion B13 | | | | | | | | | | | | | |
| Water-soluble | X | 2,3-Butanediol (b.p. 182) | | | | | 25.0 | | | | 25.0 | 30.0 | | 30.0 |
| Organic | | Propylene Glycol (b.p. 188) | | 30.0 | | | | 30.0 | 30.0 | 30.0 | | | | |
| Solvent | | 1,2,6-Hexanetriol (b.p. 178) | 25.0 | | | | | | | | | | 30.0 | |
| | Y | 1,2-Butanediol (b.p. 193) | 10.0 | | | 37.0 | 10.0 | | | 7.0 | | 7.0 | | |
| | | Diethylene Glycol Monomethyl Ether | | | 35.0 | | | 7.0 | 5.0 | | | | 5.0 | 7.0 |
| | | (b.p. 194) | | | | | | | | | | | | |
| | | Ethylene Glycol Mono-2-Ethylhexyl | | 7.0 | | | | | | | 10.0 | | | |
| | | Ether (b.p. 229) | | | | | | | | | | | | |
| | G | Glycerin (b.p. 290) | 4.0 | | | 4.0 | 4.0 | | | 4.0 | 4.0 | | | 4.0 |
| | | Triethylene Glycol (b.p. 285) | | 4.0 | | | | 4.0 | 4.0 | | | | 4.0 | |
| | | Diethylene Glycol (b.p. 245) | | | | | | | | | | 4.0 | | |
| Penetrant | | 2-Ethyl-1,3-hexanediol | | | | | 1.0 | 1.0 | 1.0 | 1.0 | | | | |
| | | 2,2,4-Trimethyl-1,3-pentanediol | 1.0 | 1.0 | 1.0 | 1.0 | | | | | 1.0 | 1.0 | 1.0 | 1.0 |

| | | | | | | | | | | | | | |
|---|---|---|---|---|---|---|---|---|---|---|---|---|---|
| Surfactant | Zonyl ® FS-300 | | | | | 2.5 | 2.5 | 2.5 | 2.5 | | | | |
| | SOFTANOL EP-7025 | | | | | | | | | | | | |
| | UNIDYNE DSN-403N | 0.5 | 0.5 | 0.5 | 0.5 | | | | | 0.5 | 0.5 | 0.5 | 0.5 |
| Antifungal | Proxel GXL | 0.05 | 0.05 | 0.05 | 0.05 | 0.05 | 0.05 | 0.05 | 0.05 | 0.05 | 0.05 | 0.05 | 0.05 |
| agent | | | | | | | | | | | | | |
| Defoamer | Silicone Defoamer KM-72F | 0.1 | 0.1 | 0.1 | 0.1 | 0.1 | 0.1 | 0.1 | 0.1 | 0.1 | 0.1 | 0.1 | 0.1 |
| Aliphatic Diol | SURFYNOL AD01 | 0.30 | 0.10 | 0.50 | 0.50 | 0.15 | 0.70 | 0.60 | 0.26 | 0.25 | 0.10 | 0.40 | 0.05 |

| | | | | | | | | | | | | |
|---|---|---|---|---|---|---|---|---|---|---|---|---|
| Pure Water | Residual | Residual | Residual | Residual | Residual | Residual | Residual | Residual | Residual | Residual | Residual | Residual |
| | quantity | quantity | quantity | quantity | quantity | quantity | quantity | quantity | quantity | quantity | quantity | quantity |
| Total | 100.0 | 100.0 | 100.0 | 100.0 | 100.0 | 100.0 | 100.0 | 100.0 | 100.0 | 100.0 | 100.0 | 100.0 |

TABLE 5-3

| | | | Comparative Examples | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| | | | K | C | M | Y | K | C | M | Y | K | C | M | Y |
| Resin-Coated | Resin-Coated Pigment Dispersion Liquid 1 | | | | | | | | | | | | | |
| Pigment | Resin-Coated Pigment Dispersion Liquid 2 | | | | | | | | | | | | | |
| Dispersion | Resin-Coated Pigment Dispersion Liquid 3 | | | | | | | | | | | | | |
| Liquid | Resin-Coated Pigment Dispersion Liquid 4 | | | | | | | | | | | | | |
| | Resin-Coated Pigment Dispersion Liquid 5 | | | | | | | | | | | | | |
| | Resin-Coated Pigment Dispersion Liquid 6 | | | | | | | | | | | | | |
| | Resin-Coated Pigment Dispersion Liquid 7 | | | | | | | | | | | | | |
| | Resin-Coated Pigment Dispersion Liquid 8 | | | | | | | | | | | | | |
| | Resin-Coated Pigment Dispersion Liquid 9 | | | | | | | | | | | | | |
| | Resin-Coated Pigment Dispersion Liquid 10 | | | | | | | | | | | | | |
| | Resin-Coated Pigment Dispersion Liquid 11 | | | | | | | | | | | | | |
| | Resin-Coated Pigment Dispersion Liquid 12 | | | | | | | | | | | | | |
| | Resin-Coated Pigment Dispersion Liquid 13 | | | | | | | | | | | | | |
| | Resin-Coated Pigment Dispersion Liquid 14 | | | | | | | | | | | | | |
| | Resin-Coated Pigment Dispersion Liquid 15 | | | | | | | | | | | | | |
| | Resin-Coated Pigment Dispersion Liquid 16 | | | | | | | | | | | | | |
| | Resin-Coated Pigment Dispersion Liquid 17 | | | | | | | | | | | | | |
| | Resin-Coated Pigment Dispersion Liquid 18 | | | | | | | | | | | | | |
| | Resin-Coated Pigment Dispersion Liquid 19 | | | | | | | | | | | | | |
| | Resin-Coated Pigment Dispersion Liquid 20 | | | | | | | | | | | | | |
| | Resin-Coated Pigment Dispersion Liquid 21 | | | | | | | | | | | | | |
| | Resin-Coated Pigment Dispersion Liquid 22 | | | | | | | | | | | | | |
| | Resin-Coated Pigment Dispersion Liquid 23 | | | | | | | | | | | | | |
| | Resin-Coated Pigment Dispersion Liquid 24 | | | | | | | | | | | | | |
| | Resin-Coated Pigment Dispersion Liquid 25 | | 40.0 | | | | | | | | | | | |
| | Resin-Coated Pigment Dispersion Liquid 26 | | | 40.0 | | | | | | | | | | |
| | Resin-Coated Pigment Dispersion Liquid 27 | | | | 40.0 | | | | | | | | | |
| | Resin-Coated Pigment Dispersion Liquid 28 | | | | | 40.0 | | | | | | | | |
| | Resin-Coated Pigment Dispersion Liquid 29 | | | | | | 40.0 | | | | | | | |
| | Resin-Coated Pigment Dispersion Liquid 30 | | | | | | | 40.0 | | | | | | |
| | Resin-Coated Pigment Dispersion Liquid 31 | | | | | | | | 40.0 | | | | | |
| | Resin-Coated Pigment Dispersion Liquid 32 | | | | | | | | | 40.0 | | | | |
| | Resin-Coated Pigment Dispersion Liquid 33 | | | | | | | | | | 40.0 | | | |
| | Resin-Coated Pigment Dispersion Liquid 34 | | | | | | | | | | | 40.0 | | |
| | Resin-Coated Pigment Dispersion Liquid 35 | | | | | | | | | | | | 40.0 | |
| | Resin-Coated Pigment Dispersion Liquid 36 | | | | | | | | | | | | | 40.0 |
| Resin | Resin Emulsion B1 | | | | | | | | | | | | | |
| Emulsion | Resin Emulsion B2 | | 4.7 | | | | | | | | | | | |
| | Resin Emulsion B3 | | | | | 21.7 | | | | | 6.7 | | | |
| | Resin Emulsion B4 | | | | | | | | | | | 6.7 | | |
| | Resin Emulsion B5 | | | | | | 8.2 | | | | | | | |
| | Resin Emulsion B6 | | | | | | | | | 22.0 | | | | 6.7 |
| | Resin Emulsion B7 | | | 13.3 | | | | | | | | | | |
| | Resin Emulsion B8 | | | | | | | | | | | | 6.7 | |
| | Resin Emulsion B9 | | | | | | | | | | | | | |
| | Resin Emulsion B10 | | | | | | | 6.7 | | | | | | |
| | Resin Emulsion B11 | | | | 1.3 | | | | | | | | | |
| | Resin Emulsion B12 | | | | | | | | | | | | | |
| | Resin Emulsion B13 | | | | | | | | 10.0 | | | | | |
| Water-soluble | X | 2.3-Butanediol (b.p. 182) | | 30.0 | | 30.0 | 25.0 | | | 30.0 | | | | 30.0 |
| Organic | | Propylene Glycol (b.p. 188) | 25.0 | | 35.0 | | | 30.0 | 35.0 | | 25.0 | 30.0 | 30.0 | |
| Solvent | | 1,2,6-Hexanetriol (b.p. 178) | | | | | | | | | | | | |
| | Y | 1,2-Butanediol (b.p. 193) | 10.0 | | | 7.0 | 10.0 | | | 7.0 | 10.0 | 7.0 | 5.0 | |
| | | Diethylene Glycol Monomethyl Ether | | 7.0 | | | | 7.0 | | | | | | |
| | | (b.p 194) | | | | | | | | | | | | |
| | | Ethylene Glycol Mono-2-Ethylhexyl | | | | | | | | | | | | 7.0 |
| | | Ether (b.p. 229) | | | | | | | | | | | | |
| | G | Glycerin (b.p. 290) | 4.0 | | 4.0 | 4.0 | 4.0 | | 4.0 | | 4.0 | 4.0 | 4.0 | |
| | | Triethylene Glycol (b.p. 285) | | 4.0 | | | | | | | | | | 4.0 |
| | | Diethylene Glycol (b.p. 245) | | | | | | 4.0 | | | | | | |
| Penetrant | | 2-Ethyl-1,3-hexanediol | 1.0 | 1.0 | | | | | 1.0 | 1.0 | 1.0 | 1.0 | | |
| | | 2,2,4-Trimethyl-1,3-pentanediol | | | 1.0 | 1.0 | 1.0 | 1.0 | | | | | 1.0 | 1.0 |
| Surfactant | | Zonyl ® FS-300 | | | | | | | | | | | | |
| | | SOFTANOL EP-7025 | | | | | | | | | 1.0 | 1.0 | 1.0 | 1.0 |
| | | UNIDYNE DSN-403N | 0.5 | 0.5 | 0.5 | 0.5 | 0.5 | 0.5 | 0.5 | 0.5 | | | | |

| | | | | | | | | | | | | | |
|---|---|---|---|---|---|---|---|---|---|---|---|---|---|
| Antifungal | Proxel GXL | 0.05 | 0.05 | 0.05 | 0.05 | 0.05 | 0.05 | 0.05 | 0.05 | 0.05 | 0.05 | 0.05 | 0.05 |
| agent | | | | | | | | | | | | | |
| Defoamer | Silicone Defoamer KM-72F | 0.1 | 0.1 | 0.1 | 0.1 | 0.1 | 0.1 | 0.1 | 0.1 | 0.1 | 0.1 | 0.1 | 0.1 |
| Aliphatic Diol | SURFYNOL AD01 | 0.10 | 0.30 | 0.30 | 0.50 | 0.30 | 0.50 | 0.04 | 0.30 | 0.30 | 0.30 | 0.30 | 0.80 |

| | | | | | | | | | | | | |
|---|---|---|---|---|---|---|---|---|---|---|---|---|
| Pure Water | Residual | Residual | Residual | Residual | Residual | Residual | Residual | Residual | Residual | Residual | Residual | Residual |
| | quantity | quantity | quantity | quantity | quantity | quantity | quantity | quantity | quantity | quantity | quantity | quantity |
| Total | 100.0 | 100.0 | 100.0 | 100.0 | 100.0 | 100.0 | 100.0 | 100.0 | 100.0 | 100.0 | 100.0 | 100.0 |

In Tables 5-1 to 5-3, numerical values represent parts by mass, unless otherwise specified.

The trade names listed in Tables 5-1 and 5-2 represent the following compounds. Zonyl® FS-300: Polyoxyethylene perfluoroalkyl ether (available from E. I. du Pont de Nemours and Company, including 40% by mass of active ingredient) SOFTANOL EP-7025: Polyoxyalkylene alkyl ether (available from NIPPON SHOKLIBAI CO., LTD., including 100% by mass of active ingredient) UNIDYNE™ DSN-403N: Perfluoroalkyl polyethylene oxide adduct (available from Daikin Industries, Ltd., including 100% by mass of active ingredient) m PROXEL GXL: Antifungal agent composed mainly of 1,2-benzisothiazolin-3-one (available from Avecia, including 20% by mass of active ingredient and dipropylene glycol) KM-72F: Self-emulsifiable silicone defoamer (available from Shin-Etsu Silicone (Shin-Etsu Chemical Co., Ltd.), including 100% by mass of active ingredient) SURFYNOL AD01: Aliphatic diol (available from Nissin Chemical Industry Co., Ltd., including 100% by mass of active ingredient)

The compositions of these inks are described in Table 6.

TABLE 6

| | | | Total | | | | | | | | | | | | | | |
|---|---|---|---|---|---|---|---|---|---|---|---|---|---|---|---|---|---|
| | | | Content | | | | | | | | | | | | | | |
| | | Content Rate | Rate of | | | | | | | Particle | Content | | | | | | |
| | | of Resin (B) | Resins | Resin (A) | | | Resin (B) | | | Diameter | Rate of | Organic Solvent (G) | | Organic Solvent (X) | | Organic Solvent (Y) | |
| | | in Resins | (A) + (B) | | | Content | | | Content | of Resin | Aliphatic | | Content | | Content | | Content |
| | Ink | (A) + (B) | in Ink | | | Rate | | | Rate | (B) | Diol | Organic | Rate | Organic | Rate | Organic | Rate |
| | Color | (%) | (%) | Polymer | | (%) | Polymer | | (%) | (nm) | (%) | Solvent (G) | (%) | Solvent (X) | (%) | Solvent (Y) | (%) |
| Example 1 | K | 40 | 2 | Vinyl | A1 | 1.2 | Vinyl | A1 | 0.8 | 10 | 0.30 | Glycerin | 4 | Propylene Glycol | 25 | 1,2-Butanediol | 10 |
| | | | | | | | | | | | | (b.p. 290) | | (b.p. 188) | | (b.p. 193) | |
| Example 2 | C | 50 | 7 | Vinyl | A1 | 3.5 | Vinyl | A2 | 3.5 | 15 | 0.50 | Triethylene | 4 | 2,3-Butanediol | 30 | Diethylene Glycol | 7 |
| | | | | | | | | | | | | Glycol | | (b.p. 182) | | Monomethyl Ether | |
| | | | | | | | | | | | | (b.p. 285) | | | | (b.p. 194) | |
| Example 3 | M | 30 | 9 | Polyester | A3 | 6.3 | Polyester | A4 | 2.7 | 19 | 0.10 | Glycerin | 4 | Propylene Glycol | 35 | — | — |
| | | | | | | | | | | | | (b.p. 290) | | (b.p. 188) | | | |
| Example 4 | Y | 45 | 4 | Polyurethane | A5 | 2.2 | Polyurethane | A5 | 1.8 | 10 | 0.70 | Glycerin | 4 | Propylene Glycol | 30 | Diethylene Glycol | 7 |
| | | | | | | | | | | | | (b.p. 290) | | (b.p. 188) | | Monomethyl Ether | |
| | | | | | | | | | | | | | | | | (b.p. 194) | |
| Example 5 | K | 55 | 7 | Vinyl | A2 | 3.2 | Vinyl | A1 | 3.9 | 10 | 0.10 | Triethylene | 4 | 2,3-Butanediol | 25 | 1,2-Butanediol | 10 |
| | | | | | | | | | | | | Glycol | | (b.p. 182) | | (b.p. 193) | |
| | | | | | | | | | | | | (b.p. 285) | | | | | |
| Example 6 | C | 40 | 11 | Polyester | A4 | 6.6 | Polyester | A3 | 4.4 | 15 | 0.50 | Glycerin | 4 | Propylene Glycol | 30 | 1,2-Butanediol | 7 |
| | | | | | | | | | | | | (b.p. 290) | | (b.p. 188) | | (b.p. 193) | |
| Example 7 | M | 35 | 5 | Polyurethane | A6 | 3.3 | Polyurethane | A5 | 1.8 | 10 | 0.05 | Glycerin | 4 | 2,3-Butanediol | 35 | — | — |
| | | | | | | | | | | | | (b.p. 290) | | (b.p. 182) | | | |
| Example 8 | Y | 50 | 6 | Vinyl | A1 | 3.0 | Vinyl | A1 | 3.0 | 8 | 0.25 | Triethylene | 4 | Propylene Glycol | 30 | 1,2-Butanediol | 7 |
| | | | | | | | | | | | | Glycol | | (b.p. 188) | | (b.p. 193) | |
| | | | | | | | | | | | | (b.p. 285) | | | | | |
| Example 9 | K | 45 | 9 | Vinyl | A2 | 5.0 | Vinyl | A2 | 4.1 | 15 | 0.26 | Glycerin | 4 | Propylene Glycol | 25 | Diethylene Glycol | 10 |
| | | | | | | | | | | | | (b.p. 290) | | (b.p. 188) | | Monomethyl Ether | |
| | | | | | | | | | | | | | | | | (b.p. 194) | |
| Example 10 | C | 35 | 5 | Vinyl | A2 | 3.3 | Vinyl | A1 | 1.8 | 10 | 0.04 | Glycerin | 4 | Propylene Glycol | 30 | 1,2-Butanediol | 7 |
| | | | | | | | | | | | | (b.p. 290) | | (b.p. 188) | | (b.p. 193) | |
| Example 11 | M | 40 | 7 | Vinyl | A1 | 4.2 | Vinyl | A2 | 2.8 | 15 | 0.80 | Glycerin | 4 | Propylene Glycol | 35 | — | — |
| | | | | | | | | | | | | (b.p. 290) | | (b.p. 188) | | | |
| Example 12 | Y | 50 | 4 | Polyester | A3 | 2.0 | Polyester | A3 | 2.0 | 15 | 0.50 | Diethylene | 4 | 2,3-Butanediol | 30 | 1,2-Butanediol | 7 |
| | | | | | | | | | | | | Glycol | | (b.p. 182) | | (b.p. 193) | |
| | | | | | | | | | | | | (b.p. 245) | | | | | |
| Example 13 | K | 45 | 5 | Polyurethane | A5 | 2.8 | Polyurethane | A6 | 2.3 | 15 | 0.30 | Glycerin | 4 | 1,2,6-Hexanetriol | 25 | 1,2-Butanediol | 10 |
| | | | | | | | | | | | | (b.p. 290) | | (b.p. 178) | | (b.p. 193) | |
| Example 14 | C | 35 | 5 | Vinyl | A2 | 3.3 | Vinyl | A1 | 1.8 | 10 | 0.10 | Triethylene | 4 | Propylene Glycol | 30 | Ethylene Glycol | 7 |
| | | | | | | | | | | | | Glycol | | (b.p. 188) | | Mono-2-Ethylhexyl | |
| | | | | | | | | | | | | (b.p. 285) | | | | Ether (b.p. 229) | |
| Example 15 | M | 40 | 10 | Vinyl | A1 | 6.0 | Vinyl | A2 | 4.0 | 15 | 0.50 | — | | — | — | Diethylene Glycol | 35 |
| | | | | | | | | | | | | | | | | Monomethyl Ether | |
| | | | | | | | | | | | | | | | | (b.p. 194) | |
| Example 16 | Y | 40 | 5 | Vinyl | A1 | 3.0 | Vinyl | A1 | 2.0 | 8 | 0.50 | Glycerin | 4 | — | — | 1,2-Butanediol | 37 |
| | | | | | | | | | | | | (b.p. 290) | | | | (b.p. 193) | |
| Example 17 | K | 40 | 10 | Polyurethane | A6 | 6.0 | Polyurethane | A5 | 4.0 | 10 | 0.15 | Glycerin | 4 | 2,3-Butanediol | 25 | 1,2-Butanediol | 10 |
| | | | | | | | | | | | | (b.p. 290) | | (b.p. 182) | | (b.p. 193) | |
| Example 18 | C | 30 | 5 | Polyurethane | A5 | 3.5 | Polyurethane | A6 | 1.5 | 19 | 0.70 | Triethylene | 4 | Propylene Glycol | 30 | Diethylene Glycol | 7 |
| | | | | | | | | | | | | Glycol | | (b.p. 188) | | Monomethyl Ether | |
| | | | | | | | | | | | | (b.p. 285) | | | | (b.p. 194) | |
| Example 19 | M | 35 | 6 | Polyurethane | A5 | 3.9 | Polyurethane | A5 | 2.1 | 8 | 0.60 | Triethylene | 4 | Propylene Glycol | 30 | Diethylene Glycol | 5 |
| | | | | | | | | | | | | Glycol | | (b.p. 188) | | Monomethyl Ether | |
| | | | | | | | | | | | | (b.p. 285) | | | | (b.p. 194) | |
| Example 20 | Y | 55 | 11 | Polyurethane | A6 | 5.0 | Polyurethane | A6 | 6.1 | 15 | 0.26 | Glycerin | 4 | Propylene Glycol | 30 | 1,2-Butanediol | 7 |
| | | | | | | | | | | | | (b.p. 290) | | (b.p. 188) | | (b.p. 193) | |
| Example 21 | K | 40 | 2 | Polyurethane | A6 | 1.2 | Polyurethane | A5 | 0.8 | 10 | 0.25 | Glycerin | 4 | 2,3-Butanediol | 25 | Ethylene Glycol | 10 |
| | | | | | | | | | | | | (b.p. 290) | | (b.p. 182) | | Mono-2-Ethylhexyl | |
| | | | | | | | | | | | | | | | | Ether (b.p. 229) | |
| Example 22 | C | 40 | 7 | Polyurethane | A5 | 4.2 | Polyurethane | A6 | 2.8 | 15 | 0.10 | Diethylene | 4 | 2,3-Butanediol | 30 | 1,2-Butanediol | 7 |
| | | | | | | | | | | | | Glycol | | (b.p. 182) | | (b.p. 193) | |
| | | | | | | | | | | | | (b.p. 245) | | | | | |
| Example 23 | M | 40 | 4 | Polyurethane | A6 | 2.4 | Polyurethane | A5 | 1.6 | 10 | 0.40 | Triethylene | 4 | 1,2,6-Hexanetriol | 30 | Diethylene Glycol | 5 |
| | | | | | | | | | | | | Glycol | | (b.p. 178) | | Monomethyl Ether | |
| | | | | | | | | | | | | (b.p. 285) | | | | (b.p. 194) | |
| Example 24 | Y | 40 | 10 | Polyurethane | A6 | 6.0 | Polyurethane | A5 | 4.0 | 10 | 0.05 | Glycerin | 4 | 2,3-Butanediol | 30 | Diethylene Glycol | 7 |
| | | | | | | | | | | | | (b.p. 290) | | (b.p. 182) | | Monomethyl Ether | |
| | | | | | | | | | | | | | | | | (b.p. 194) | |
| Comparative | K | 28 | 5 | Vinyl | A1 | 3.6 | Vinyl | A1 | 1.4 | 10 | 0.10 | Glycerin | 4 | Propylene Glycol | 25 | 1,2-Butanediol | 10 |
| Example 1 | | | | | | | | | | | | (b.p. 290) | | (b.p. 188) | | (b.p. 193) | |
| Comparative | C | 57 | 7 | Polyester | A3 | 3.0 | Polyester | A4 | 4.0 | 19 | 0.30 | Triethylene | 4 | 2,3-Butanediol | 30 | Diethylene Glycol | 7 |
| Example 2 | | | | | | | | | | | | Glycol | | (b.p. 182) | | Monomethyl Ether | |
| | | | | | | | | | | | | (b.p. 285) | | | | (b.p. 194) | |
| Comparative | M | 40 | 1 | Polyurethane | A6 | 0.6 | Polyurethane | A6 | 0.4 | 15 | 0.30 | Glycerin | 4 | Propylene Glycol | 35 | — | — |
| Example 3 | | | | | | | | | | | | (b.p. 290) | | (b.p. 188) | | | |
| Comparative | Y | 50 | 13 | Vinyl | A2 | 6.5 | Vinyl | A2 | 6.5 | 15 | 0.50 | Glycerin | 4 | 2,3-Butanediol | 30 | 1,2-Butanediol | 7 |
| Example 4 | | | | | | | | | | | | (b.p. 290) | | (b.p. 182) | | (b.p. 193) | |
| Comparative | K | 35 | 7 | Vinyl | A1 | 4.6 | Polyester | A3 | 2.5 | 5 | 0.30 | Glycerin | 4 | 2,3-Butanediol | 25 | 1,2-Butanediol | 10 |
| Example 5 | | | | | | | | | | | | (b.p. 290) | | (b.p. 182) | | (b.p. 193) | |
| Comparative | C | 40 | 5 | Vinyl | A2 | 3.0 | Polyurethane | A5 | 2.0 | 10 | 0.50 | Diethylene | 4 | Propylene Glycol | 30 | Diethylene Glycol | 7 |
| Example 6 | | | | | | | | | | | | Glycol | | (b.p. 188) | | Monomethyl Ether | |
| | | | | | | | | | | | | (b.p. 245) | | | | (b.p. 194) | |
| Comparative | M | 50 | 6 | Polyester | A4 | 3.0 | Polyurethane | A5 | 3.0 | 20 | 0.04 | Glycerin | 4 | Propylene Glycol | 35 | — | — |
| Example 7 | | | | | | | | | | | | (b.p. 290) | | (b.p. 188) | | | |
| Comparative | Y | 60 | 11 | Vinyl | A1 | 4.4 | Polyester | A3 | 6.6 | 15 | 0.30 | — | | 2,3-Butanediol | 30 | 1,2-Butanediol | 7 |
| Example 8 | | | | | | | | | | | | | | (b.p. 182) | | (b.p. 193) | |
| Comparative | K | 40 | 5 | Polyurethane | A5 | 3.0 | Vinyl | A2 | 2.0 | 15 | 0.30 | Glycerin | 4 | Propylene Glycol | 25 | 1,2-Butanediol | 10 |
| Example 9 | | | | | | | | | | | | (b.p. 290) | | (b.p. 188) | | (b.p. 193) | |
| Comparative | C | 40 | 5 | Vinyl | A1 | 3.0 | Vinyl | A2 | 2.0 | 22 | 0.30 | Glycerin | 4 | Propylene Glycol | 30 | 1,2-Butanediol | 7 |
| Example 10 | | | | | | | | | | | | (b.p. 290) | | (b.p. 188) | | (b.p. 193) | |
| Comparative | M | 40 | 5 | Polyurethane | A5 | 3.0 | Polyurethane | A5 | 2.0 | 7 | 0.30 | Glycerin | 4 | Propylene Glycol | 30 | 1,2-Butanediol | 5 |
| Example 11 | | | | | | | | | | | | (b.p. 290) | | (b.p. 188) | | (b.p. 193) | |
| Comparative | Y | 40 | 5 | Polyurethane | A6 | 3.0 | Polyester | A3 | 2.0 | 15 | 0.80 | Triethylene | 4 | 2,3-Butanediol | 30 | Ethylene Glycol | 7 |
| Example 12 | | | | | | | | | | | | Glycol | | (b.p. 182) | | Mono-2-Ethylhexyl | |
| | | | | | | | | | | | | (b.p. 285) | | | | Ether (b.p. 229) | |

Properties of the inks prepared in Examples 1 to 24 and Comparative Examples 1 to 12 were measured as follows. The measurement results are shown in Table 7.

### Image Density

Each ink was filled in an inkjet printer IPSIO GX5500 (available from Ricoh Co., Ltd.). Sheets of a paper Lumi Art Gloss 130 gsm (available from Stora Enso) were set in the printer. The printer was allowed to print a chart having a symbol “.” with a font size of 64 point, prepared with MICROSOFT WORD 2000, at a resolution of 600 dpi.

After being dried, the printed image was subjected to a measurement of image density using a reflective color spectrophotometric densitometer (available from X-Rite). The measured image density was evaluated based on the following criteria. The grades A, B, and C are acceptable.

Evaluation Criteria

A: Black ID=not less than 1.6, Yellow ID=not less than 1.1, Magenta ID=not less than 1.4, Cyan ID=not less than 1.6

B: Black ID=not less than 1.3 and less than 1.6, Yellow ID=not less than 1.0 and less than 1.1, Magenta ID=not less than 1.1 and less than 1.4, Cyan ID=not less than 1.3 and less than 1.6

C: Black ID=not less than 1.1 and less than 1.3, Yellow ID =not less than 0.8 and less than 1.0, Magenta ID=not less than 0.9 and less than 1.1, Cyan ID=not less than 1.1 and less than 1.3

D: Black ID=less than 1.1, Yellow ID=less than 0.8, Magenta ID=less than 0.9, Cyan ID=less than 1.1

### Rub Resistance

Each ink was filled in an inkjet printer IPSIO GX5500 (available from Ricoh Co., Ltd.). Sheets of a paper Lumi Art Gloss 130 gsm (available from Stora Enso) were set in the printer. The printer was allowed to print an image at a resolution of 600 dpi. After being dried, the printed image was rubbed with a piece of paper Lumi Art Gloss 130 gsm, with each sides having a length of 1.2 mm, 20 times. The piece pf paper was subjected to a measurement using a reflective color spectrophotometric densitometer (available from X-Rite) to determine the density of the ink transferred thereon. Specifically, the transferred ink density was determined by subtracting the background density of the paper from the above-measured density, and evaluated based on the following criteria. The grades A, B, and C are acceptable.

Evaluation Criteria

A: The transferred ink density was less than 0.13.

B: The transferred ink density was not less than 0.13 and less than 0.17.

C: The transferred ink density was not less than 0.17 and less than 0.20.

D: The transferred ink density was not less than 0.20.

### Glossiness

Each ink was filled in an inkjet printer IPSIO GX5500 (available from Ricoh Co., Ltd.). The printer was allowed to print a solid image on a glossy medium Ricoh Business Coat Gloss 100 (having a 60° background glossiness of 21) at a resolution of 1,200 dpi. After being dried, the printed image was subjected to a measurement of 60° glossiness using a gloss meter Micro-Gross 60° (available from BYK Gardner). The measured 60° glossiness was evaluated based on the following criteria. The grades A, B, and C are acceptable.

Evaluation Criteria

A: not less than 30%

B: not less than 25% and less than 30%

C: not less than 20% and less than 25%

D: less than 20%

### Temporal Stability

Each ink was subjected to a measurement of an initial viscosity. The ink was thereafter stored in a thermostatic chamber at 70° C. for 2 weeks. After being taken out of the chamber, the ink was subjected to a measurement of a viscosity after storage. The rate of change of viscosity before and after the storage is calculated and evaluated based on the following criteria.

The viscosity was measured with a viscometer (RE-550L available from Toki Sangyo Co., Ltd.) at 25° C. The grades A, B, and C are acceptable.

Evaluation Criteria

A: The rate of change of viscosity was less than 5%.

B: The rate of change of viscosity was not less than 5% and less than 7%.

C: The rate of change of viscosity was not less than 7% and less than 10%.

D: The rate of change of viscosity was not less than 10%.

### Discharge Stability

Each ink was filled in an inkjet printer IPSIO GX5500 (available from Ricoh Co., Ltd.). An A4-size chart including solid parts having an area ratio of 5% per color, prepared with MICROSOFT WORD 2000, was continuously printed on 200 sheets of MY PAPER (available from Ricoh Co., Ltd.). Thereafter, discharge stability was evaluated based on the degree of disturbance in discharge at each nozzle. The printing mode “Plain paper/Fast” was modified to “No color correction” through the user setting for plain paper using a driver attached to the printer. The grades A, B, and C are acceptable.

Evaluation Criteria

A: Disturbance in discharge was not observed.

B: Disturbance in discharge was observed at 1 ch or more and less than 5 ch, or discharge was not performed in part.

C: Disturbance in discharge was observed at 5 ch or more and less than 10 ch, or discharge was not performed in part.

D: Disturbance in discharge was observed at 10 ch or more, or discharge was not performed in part.

### Maintainability

Each ink was filled in an inkjet printer IPSIO GX5500 (available from Ricoh Co., Ltd.). The printer, in a decap state, was left at rest in a thermostatic chamber at 40° C. for 24 hours. The printer was then taken out from the chamber and subjected to head refreshing through the printer driver. The grades A, B, and C are acceptable.

Evaluation Criteria

A: All nozzles discharged the ink after less than 4 times of head refreshing.

B: All nozzles discharged the ink after not less than 4 times and less than 7 times of head refreshing.

C: All nozzles discharged the ink after not less than 7 times and less than 10 times of head refreshing.

D: All nozzles discharged the ink after not less than 10 times of head refreshing.

TABLE 7

| | Image | Rub | | Temporal | Discharge | |
|---|---|---|---|---|---|---|
| | Density | Resistance | Glossiness | Stability | Stability | Maintainability |
| Example 1 | A | C | B | A | B | A |
| Example 2 | A | B | A | A | B | A |
| Example 3 | A | B | A | A | A | A |
| Example 4 | A | B | B | A | B | A |
| Example 5 | A | B | A | A | A | A |
| Example 6 | A | B | A | A | B | A |
| Example 7 | A | B | B | A | A | A |
| Example 8 | A | B | A | A | A | A |
| Example 9 | A | B | A | A | B | A |
| Example 10 | A | C | B | A | C | A |
| Example 11 | A | B | A | A | C | A |
| Example 12 | A | C | B | B | B | B |
| Example 13 | A | B | B | B | B | B |
| Example 14 | A | C | B | A | A | A |
| Example 15 | A | B | A | B | B | C |
| Example 16 | A | C | B | A | B | A |
| Example 17 | A | A | A | A | A | A |
| Example 18 | A | B | B | A | B | A |
| Example 19 | A | A | A | A | B | A |
| Example 20 | A | A | A | A | B | A |
| Example 21 | A | B | B | A | A | A |
| Example 22 | A | A | A | B | A | B |
| Example 23 | A | B | B | B | B | B |
| Example 24 | A | A | A | A | A | A |
| Comparative | A | D | D | A | A | A |
| Example 1 | | | | | | |
| Comparative | A | B | A | D | D | D |
| Example 2 | | | | | | |
| Comparative | A | D | D | A | B | A |
| Example 3 | | | | | | |
| Comparative | D | B | A | D | D | D |
| Example 4 | | | | | | |
| Comparative | A | D | D | D | B | A |
| Example 5 | | | | | | |
| Comparative | A | D | D | D | B | B |
| Example 6 | | | | | | |
| Comparative | A | D | D | D | D | A |
| Example 7 | | | | | | |
| Comparative | A | D | D | D | D | D |
| Example 8 | | | | | | |
| Comparative | A | D | D | D | B | A |
| Example 9 | | | | | | |
| Comparative | A | C | D | A | D | A |
| Example 10 | | | | | | |
| Comparative | A | D | B | D | B | A |
| Example 11 | | | | | | |
| Comparative | A | D | D | D | C | A |
| Example 12 | | | | | | |

Table 7 indicates that the Example inks satisfying the following conditions are excellent in rub resistance, glossiness, image density, temporal stability, discharge stability, and maintainability: the total content rate of the resin (A) and the resin (B) in the ink ranges from 2% to 11% by mass, the resin (B) has the same composition as the resin (A), the content of the resin (B) ranges from 30% to 55% by mass of the total content of the resin (A) and the resin (B), and the resin (B) has a volume average particle diameter of from 8 to 19 nm.

In Comparative Examples 1 and 3, rub resistance and glossiness are poor. This is because the adhesive force between the resin-coated pigment particles is lowered and the spaces between the resin-coated pigment particles are not sufficiently filled with the resin, since the total content of the resins in the ink is too small, or the content rate of the resin (B) is too small relative to the total content of the resins. In Comparative Examples 2 and 4, ink discharge stability and head maintainability are poor. This is because the ink adheres to the wall surfaces of nozzles or notably forms its film when dried at the meniscus parts, since the total content of the resins in the ink is too large, or the content rate of the resin (B) is too large relative to the total content of the resins. In addition, since the content rate of the resin (B) is too large, the resin emulsion aggregates to degrade ink stability.

In Comparative Examples 5 to 9 and 12, rub resistance and glossiness are poor. This is because the adhesive force between the resin-coated pigment particles is lowered and the spaces between the resin-coated pigment particles are not sufficiently tilled with the resin, since the resin (A) and the resin (B) have different compositions and therefore compatibility therebetween is low. In addition, since heterogeneous resins are coexisting, dispersibility of the pigment and the resin easily becomes unstable while significantly changing the ink viscosity with time.

In Comparative Example 10, since the particle diameter of the resin (B) in the emulsion is too large, the resulting image has a rough surface, resulting in low glossiness. In addition, the resin easily accumulates on the wall surfaces of nozzles to degrade ink discharge stability.

In Comparative Example 11, since the particle diameter of the resin (B) in the emulsion is too small, the resin densely covers the surface of the image and excessively flattens the surface. The flattened surface generates a high frictional force when rubbed, resulting in poor rub resistance.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An ink, comprising:
water;
a water-soluble organic solvent;
a resin-coated pigment coated with a resin (A); and
a resin emulsion including a resin (B), the resin (B) having the same composition as the resin (A) and a volume average particle diameter of from 8 to 19 nm,
wherein a total content rate of the resin (A) and the resin (B) in the ink ranges from 2% to 11% by mass, and
wherein a content of the resin (B) ranges from 30% to 55% by mass of the total content of the resin (A) and the resin (B).

2. The ink according to claim 1, wherein each of the resin (A) and the resin (B) includes polyurethane.

3. The ink according to claim 1, further comprising an aliphatic diol having an unsaturated bond in an amount of from 0.05% to 0.7% by mass.

4. The ink according to claim 1, wherein the water-soluble organic solvent includes:
a water-soluble organic solvent (G) having a boiling point of from 280° C. to 300° C.; and
at least one of a water-soluble organic solvent (X) having a boiling point of from 180° C. to 190° C. and a water-soluble organic solvent (Y) having a boiling point of from 190° C. to 200° C.

5. The ink according to claim 1, wherein the ink has cyan color, magenta color, yellow color, or black color.

6. An ink cartridge, comprising:
a container; and
the ink according to claim 1 contained in the container.

7. An inkjet recording method, comprising:
applying a stimulus to the ink of claim 1 to discharge the ink; and
recording an image on a recording medium with the ink.

8. An inkjet recording apparatus, comprising:
an ink discharging device to apply a stimulus to the ink of claim 1 to discharge the ink; and
an image recorder to record an image on a recording medium with the ink.

9. Ink recorded matter, comprising:
a recording medium; and
an image formed on the recording medium with the ink of claim 1.
